(19) United States
(12) Patent Application Publication
(10) Pub. No.: US 2026/0310995 A1
(43) Pub. Date: Oct. 8, 2026

(54) SYSTEM AND METHODS OF CAPTURING AND ANALYZING PET DATA USING CONNECTED DEVICES

(71) Applicant: Tuft and Paw Incorporated, Vancouver (CA)

(72) Inventor: Rahul Vijay Bhagat, Toronto (CA)

(21) Appl. No.: 19/639,463

(22) Filed: Apr. 6, 2026

Related U.S. Application Data
(60) Provisional application No. 63/783,815, filed on Apr. 4, 2025.

(51) Int. Cl. G06N 5/022

(52) U.S. Cl. CPC G06N 5/022

(57) ABSTRACT

A system may receive, by one or more processors, sensor data captured from a sensor of a primary pet device, the sensor data including an interaction between a pet and the primary pet device. A system may determine, by the one or more processors, a profile of the pet using the sensor data. A system may update the profile of the pet to include the sensor data captured from the primary pet device.

### BACKGROUND

This application relates to systems and methods of capturing and analyzing pet data using one or more connected devices.

Currently, there are various devices used for pets. These devices can have limited smart capabilities, such as timers and/or schedules for dispensing food/treats, turning on/off heat lamps, turning on/off lights, etc. However, these devices are not able to communicate with other devices and/or a high-level remote application that can capture and analyze various data.

### SUMMARY

In some aspects, the techniques described herein relate to a computer-implemented method including: receiving, by one or more processors, sensor data captured from a sensor of a primary pet device, the sensor data including an interaction between a pet and the primary pet device; determining, by the one or more processors, a profile of the pet using the sensor data; and updating the profile of the pet to include the sensor data captured from the primary pet device.

In some aspects, the techniques described herein relate to a computer-implemented method, wherein the pet is a feline, the primary pet device is a litterbox, and wherein the interaction between the pet and the primary pet device is the feline using the litterbox.

In some aspects, the techniques described herein relate to a computer-implemented method, wherein the sensor of the primary pet device is one or more weight sensors and the sensor data includes weight data borne by each sensor of the one or more sensors captured when the feline is using the litterbox, the method further including: determining, by the one or more processors, a current weight of the feline based on the weight data; and determining, by the one or more processors, a waste weight of any feline waste left in the litterbox after the feline uses the litterbox based on the weight data; and determining, by the one or more processors, a behavior of the feline as it performs one or more actions of entering the litterbox, exiting the litterbox, and maneuvering around the litterbox based on the weight data.

In some aspects, the techniques described herein relate to a computer-implemented method, wherein updating the profile of the pet to include the sensor data captured from the primary pet device including updating the profile of the pet to include the current weight of the feline and the waste weight of any feline waste left in the litterbox.

In some aspects, the techniques described herein relate to a computer-implemented method, further including: determining, by the one or more processors, a health change in the feline by comparing one or more of the current weight of the feline to historical weight data of the feline, the waste weight produced by the feline to historical waste weight data, and the behaviors exhibited by the feline compared to historical behavior exhibited by the feline; determining, by the one or more processors, a health action based on the health change; and sending the health action to a user device.

In some aspects, the techniques described herein relate to a computer-implemented method, wherein determining the profile of the pet using the sensor data further includes: determining, by the one or more processors, one or more behavioral characteristics of the pet from the sensor data; comparing, by the one or more processors, the one or more behavioral characteristics to historical behavioral characteristics associated with the pet; determining, by the one or more processors, that the one or more behavioral characteristics match within a threshold accuracy to the historical behavioral characteristics of the pet; and associating, by the one or more processors, the one or more behavioral characteristics of the pet from the sensor data with the historical behavioral characteristics of the pet.

In some aspects, the techniques described herein relate to a computer-implemented method, wherein the sensor data is first sensor data, the pet is a first pet, the interaction is a first interaction, and the profile is a first profile, the method further including: receiving, by the one or more processors, second sensor data from the sensor of the primary pet device, the second sensor data including a second interaction between a second pet and the primary pet device; determining, by the one or more processors, a second profile of the second pet using the second sensor data; and updating, by the one or more processors, the second profile of the second pet to include the second sensor data captured from the primary pet device.

In some aspects, the techniques described herein relate to a computer-implemented method, wherein determining the first profile of the first pet using the first sensor data and determining the second profile of the second pet using the second sensor data further includes: determining, by the one or more processors, that the first sensor data includes first pet information that is associated with one or more historical first pet characteristics; determining, by the one or more processors, that the first sensor data is from the first pet based on the determination that the first sensor data includes first pet information that is associated with the one or more historical first pet characteristics; determining, by the one or more processors, the first profile of the first pet based on the determination that the first sensor data is from the first pet; determining, by the one or more processors, that the second sensor data includes second pet information that is associated with one or more historical second pet characteristics; determining, by the one or more processors, that the second sensor data is from the second pet based on the determination that the second sensor data includes second pet information that is associated with the one or more historical second pet characteristics; and determining, by the one or more processors, the second profile of the second pet based on the determination that the second sensor data is from the second pet;

In some aspects, the techniques described herein relate to a computer-implemented method, wherein the one or more historical first pet characteristics and the one or more historical second pet characteristics include pet weight characteristics, movement characteristics within the primary pet device, pet waste characteristics, and timing characteristics.

In some aspects, the techniques described herein relate to a pet identification system including: a sensor of a pet device, the sensor being configured to capture sensor data of an interaction between a pet and the pet device; and a pet management application configured to receive the sensor data of the interaction between the pet and the pet device, determine a profile of the pet using the sensor data, and update the profile of the pet to include the sensor data captured from the pet device.

In some aspects, the techniques described herein relate to a pet identification system, wherein the pet is a feline, the pet device is a litterbox, and wherein the interaction between the pet and the pet device is the feline using the litterbox.

In some aspects, the techniques described herein relate to a pet identification system, wherein the sensor of the pet device is one or more weight sensors and the sensor data includes weight data borne by each sensor of the one or more sensors captured when the feline is using the litterbox, and wherein the pet management application is further configured to: determine a current weight of the feline based on the weight data; determine a waste weight of any feline waste left in the litterbox after the feline uses the litterbox based on the weight data; and determine a behavior of the feline as it performs one or more actions of entering the litterbox, exiting the litterbox, and maneuvering around the litterbox based on the weight data.

In some aspects, the techniques described herein relate to a pet identification system, wherein updating the profile of the pet to include the sensor data captured from the pet device including updating the profile of the pet to include the current weight of the feline and the waste weight of any feline waste left in the litterbox.

In some aspects, the techniques described herein relate to a pet identification system, wherein the pet management application is further configured to: determine a health change in the feline by comparing one or more of the current weight of the feline to historical weight data of the feline, the waste weight produced by the feline to historical waste weight data, and the behaviors exhibited by the feline compared to historical behavior exhibited by the feline; determine a health action based on the health change; and send the health action to a user device.

In some aspects, the techniques described herein relate to a pet identification system, wherein the pet management application being configured to determine the profile of the pet using the sensor data is further configured to: determine one or more behavioral characteristics of the pet from the sensor data; compare the one or more behavioral characteristics to historical behavioral characteristics associated with the pet; determine that the one or more behavioral characteristics match within a threshold accuracy to the historical behavioral characteristics of the pet; and associate the one or more behavioral characteristics of the pet from the sensor data with the historical behavioral characteristics of the pet.

In some aspects, the techniques described herein relate to a pet identification system, wherein the sensor data is first sensor data, the pet is a first pet, the interaction is a first interaction, and the profile is a first profile, the wherein the sensor of the pet device is further configured to capture second sensor data of an second interaction between a second pet and the pet device; and wherein the pet management application is further configured to receive the second sensor data of the second interaction between the second pet and the pet device, determine a second profile of the second pet using the second sensor data, and update the second profile of the second pet to include the second sensor data captured from the pet device.

In some aspects, the techniques described herein relate to a pet identification system, wherein the when the pet management application determines the first profile of the first pet using the first sensor data and determines the second profile of the second pet using the second sensor data, the pet management application is further configured to: determine that the first sensor data includes first pet information that is associated with one or more historical first pet characteristics; determine that the first sensor data is from the first pet based on the determination that the first sensor data includes first pet information that is associated with the one or more historical first pet characteristics; determine the first profile of the first pet based on the determination that the first sensor data is from the first pet; determine that the second sensor data includes second pet information that is associated with one or more historical second pet characteristics; determine that the second sensor data is from the second pet based on the determination that the second sensor data includes second pet information that is associated with the one or more historical second pet characteristics; and determine the second profile of the second pet based on the determination that the second sensor data is from the second pet;

In some aspects, the techniques described herein relate to a pet identification system, wherein the one or more historical first pet characteristics and the one or more historical second pet characteristics include pet weight characteristics, movement characteristics within the pet device, pet waste characteristics, and timing characteristics.

In some aspects, the techniques described herein relate to a method of multi-pet identification including: detecting, using one or more sensors of a pet device, an interaction between a feline from a plurality of felines and the pet device, the interaction including a waste action by the feline in a litter area of the pet device; capturing, using the one or more sensors of the pet device, sensor data in response to the interaction being detected, the sensor data including the waste action by the feline in the litter area of the pet device and a behavior action by the feline in the litter area of the pet device; comparing, using one or more processors, the sensor data including the waste action and the behavior action by the feline in the litter area of the pet device to one or more of historical waste action data and historical behavior action data that includes waste actions from multiple different felines of a plurality of felines and historical behavior action data that includes behavior actions from the multiple different felines of the plurality of felines; determining, using the one or more processors, a match that exceeds a threshold accuracy between one or more characteristics of the sensor data and one or more characteristics of the one or more of the historical waste action data and the historical behavior action data that is associated with a matched feline of the plurality of felines; identifying the matched feline of the plurality of felines as the feline in the interaction with the pet device based on the determined match exceeding the threshold accuracy; and updating a profile of the matched feline to include at least a portion of the sensor data.

In some aspects, the techniques described herein relate to a method, wherein the one or more characteristics of the sensor data include one or more of a weight of the feline, an activity level of the feline, a visit duration of the feline, a waste weight of the feline, and a time characteristic of the feline.

In some aspects, the techniques described herein relate to a method including: capturing, using a first sensor of a first pet device, first sensor data, the first sensor data including a first interaction between a pet and the first pet device; capturing, using a second sensor of a second pet device, second sensor data, the second sensor data including a second interaction between the pet and the second pet device; determining a first characteristic of the pet based on the first sensor data; determining a second characteristic of the pet based on the second sensor data; updating a profile of the pet to include both the first characteristic and the second characteristic; determining a health insight based on both the first characteristic and the second characteristic; and sending the health characteristic to a user device.

In some aspects, the techniques described herein relate to a method, wherein, the first pet device is a litterbox and the first sensor is a weight sensor configured to capture one or more of a weight of the first pet when it uses the litterbox and a weight of any waste left by the first pet within the litterbox.

In some aspects, the techniques described herein relate to a method, wherein the second pet device is an automatic feeder and the second sensor is configured to capture how much food was consumed by the first pet when the first pet uses the automatic feeder.

In some aspects, the techniques described herein relate to a method, wherein the health insight is that the pet is decreasing in weight and consuming less food than expected based on the first characteristic and the second characteristic.

In some aspects, the techniques described herein relate to a method, further including: capturing, using a third sensor of a third pet device, third sensor data, the third sensor data including a third interaction between the pet and the third pet device; and determining a third characteristic based on the third sensor data.

In some aspects, the techniques described herein relate to a method, further including: updating the profile of the pet to include both the third characteristic; determining one or more pet behavioral characteristics based on the first characteristic, the second characteristic, and the third characteristic.

In some aspects, the techniques described herein relate to a method, further including: determining an identity of the pet based on the one or more pet behavioral characteristics.

In some aspects, the techniques described herein relate to a method including: receiving current pet data from a sensor of a pet device, the sensor capturing an interaction between a pet and the pet device; determining one or more characteristics of the interaction between the pet and the pet device from the current pet data; identifying using the one or more characteristics an identity of the pet; retrieving a pet profile associated with the pet based on the identity of the pet, the pet profile including previous pet data of previous interactions between the pet and the pet device; comparing the current pet data to one or more historical clinical outcomes; determining a health condition based on the comparison between the pet data and the one or more historical clinical outcomes; and sending the health condition to a user device.

In some aspects, the techniques described herein relate to a method, wherein the pet device is a litterbox and the sensor is configured to capture one or more of a weight of the pet using the litterbox, a weight of a waste left in the litterbox, and a movement of the pet within the litterbox.

In some aspects, the techniques described herein relate to a method, wherein comparing the current pet data to the one or more historical clinical outcomes further includes: determining a weight change of the pet based on the current pet data compared to previous pet data; and comparing the weight change to the one or more historical clinical outcomes.

In some aspects, the techniques described herein relate to a method, wherein comparing the current pet data to the one or more historical clinical outcomes further includes:: determining a behavioral change of the pet based on the current pet data compared to previous pet data; and comparing the behavioral change to the one or more historical clinical outcomes.

In some aspects, the techniques described herein relate to a method, wherein comparing the current pet data to the one or more historical clinical outcomes further includes: determining a usage delay of the pet using the litterbox based on the current pet data compared to previous pet data; and comparing the usage delay to the one or more historical clinical outcomes.

In some aspects, the techniques described herein relate to a method, wherein the historical clinical outcomes include data that predicts a likelihood of a specific health condition.

In some aspects, the techniques described herein relate to a method including: capturing, using a first sensor of a first pet device, first sensor data, the first sensor data including a first interaction between a pet and the first pet device; capturing, using a second sensor of a second pet device, second sensor data, the second sensor data including a second interaction between the pet and the second pet device; determining a first data point from the first sensor data; determining a second data point from the second sensor data; determining a device intervention based on the first data point and the second data point; and updating a setting of one or more of the first pet device and the second pet device based on the device intervention.

In some aspects, the techniques described herein relate to a method, wherein the first pet device is a litterbox and the first data point includes one or more of a weight of the pet and a weight of pet waste left in the litterbox;

In some aspects, the techniques described herein relate to a method, wherein the second pet device is an feeder and the second data point includes one or more of a speed that the pet consumes food from the feeder and a quantity of food consumed by the pet from the feeder.

In some aspects, the techniques described herein relate to a method, wherein determining the device intervention based on the first data point and the second data point, further includes: determining an expected waste amount for the pet based on one or more of historical pet data and the quantity of food consumed by the pet from the feeder; comparing the expected waste amount to the weight of pet waste left in the litterbox; and determining whether a health issue is present based on the comparison of the expected waste amount to the weight of pet waste left in the litterbox; and responsive to determining that a health issue is present, causing the feeder to reduce an amount of food provided to the pet.

In some aspects, the techniques described herein relate to a method, wherein determining the device intervention based on the first data point and the second data point, further includes: determining a boredom level based on the speed that the pet consumes food from the feeder and the quantity of food consumed by the pet from the feeder; and responsive to the boredom level exceeding a threshold value, causing the feeder to change a composition of the food in the feeder.

In some aspects, the techniques described herein relate to a method, wherein determining the device intervention based on the first data point and the second data point, further includes: determining a weight level score based on one or more of the speed that the pet consumes food from the feeder, the quantity of food consumed by the pet from the feeder, a weight of the pet, and a weight of the pet waste; and responsive to the weight level score exceeding a threshold value, causing the feeder to reduce an amount of food provided to the pet.

In some aspects, the techniques described herein relate to a method including: capturing, using a first sensor of a first pet device, first sensor data, the first sensor data including a first interaction between a pet and the first pet device; capturing, using a second sensor of a second pet device, second sensor data, the second sensor data including a second interaction between the pet and the second pet device; determining a first data point from the first sensor data; determining a second data point from the second sensor data; determining a health intervention based on a comparison of one or more of the first data point and the second data point to historical health interventions; and sending the health intervention to a user device.

In some aspects, the techniques described herein relate to a method, wherein the first pet device is a litterbox and the first data point includes one or more of a weight of the pet, a weight of pet waste left in the litterbox, and a movement characteristic of the pet in the litterbox;

In some aspects, the techniques described herein relate to a method, wherein the second pet device is a feeder and the second data point includes one or more of a speed that the pet consumes food from the feeder and a quantity of food consumed by the pet from the feeder.

In some aspects, the techniques described herein relate to a method, wherein determining the health intervention based on a comparison of one or more of the first data point and the second data point to historical health interventions, further includes: comparing one or more of the weight of the pet, the weight of pet waste left in the litterbox, the movement characteristic of the pet in the litterbox, the speed that the pet consumes food from the feeder, and the quantity of food consumed by the pet from the feeder to one or more behavioral deltas included in the historical health interventions; determining based on the comparison, which behavioral deltas exceeded a threshold matching value; determining which behavioral deltas that exceeded a threshold matching value resulted in a success; and providing those behavioral deltas that resulted in the success as the health intervention.

In some aspects, the techniques described herein relate to a method, further including: aggregating the first data point, the second data point, and the determination of which behavioral deltas resulted in success; and sending the aggregated data to a medical provider.

In some aspects, the techniques described herein relate to a method including: capturing, using a first sensor of a first pet device, first sensor data, the first sensor data including a first interaction between a pet and the first pet device; capturing, using a second sensor of a second pet device, second sensor data, the second sensor data including a second interaction between the pet and the second pet device; receiving external third-party data; determining, using one or more processors, a health insight based on the first sensor data and the second sensor data determining a correlation between the health insight and the external third-party data, the correlation verifying the health insight; and updating a database of verified health insights to include the correlation and the health insight.

### BRIEF DESCRIPTION OF THE DRAWINGS

FIG. 1 is a block diagram illustrating an example system for capturing and analyzing connected pet devices.

FIG. 2 depicts a block diagram of an example connected pet device.

FIG. 3 is a flowchart of an example method of identifying a profile of a pet using captured sensor data from the connected pet device.

FIG. 4 is a flowchart of an example method of determining a weight of a pet, waste weight of a pet, and/or behaviors of a pet using a connected pet device.

FIG. 5 is a flowchart of an example method of updating a pet profile to include captured sensor data from a connected pet device.

FIG. 6 is a flowchart of an example method of determining a health change in a pet using captured sensor data from a connected pet device.

FIG. 7 is a flowchart of an example method of determining an identity of a pet using determined pet behaviors.

FIG. 8 is a flowchart of an example method of multi-pet identification using captured sensor data from a connected pet device.

FIG. 9 is a flowchart of an example method of multi-pet identification using captured sensor data from a connected pet device.

FIG. 10 is a flowchart of an example method of comparing captured pet data to historical data in order to identify one or more pets from the captured sensor data of a connected pet device.

FIG. 11 is a flowchart of an example method of identifying health insights from determined characteristics of one or more pets.

FIG. 12 is a flowchart of an example method of determining pet behavioral characteristics.

FIG. 13 is a flowchart of an example method of determining a health condition of a pet using characteristics of an interaction between the pet and a connected pet device.

FIG. 14 is a flowchart of an example method of determining weight changes of one or more pets.

FIG. 15 is a flowchart of an example method of determining behavioral changes of one or more pets.

FIG. 16 is a flowchart of an example method of determining a change in usage of a connected pet device.

FIG. 17 is a flowchart of an example method of determining a device intervention based on captured sensor data from a connected pet device.

FIG. 18 is a flowchart of an example method of determining a health issue based on captured sensor data from a connected pet device.

FIG. 19 is a flowchart of an example method of determining one or more of a boredom level of a pet, a palatability level of a food consumed by a pet, and a desirability of a food consumed by a pet.

FIG. 20 is a flowchart of an example method of determining a weight level score and adjusting one or more settings of a connected pet device based on the weight level.

FIG. 21 is a flowchart of an example method of health intervention based on captured sensor data from a connected pet device.

FIG. 22 is a flowchart of an example method of determining one or more behavioral deltas of previous success for a health intervention based on captured sensor data from a connected pet device.

FIG. 23 is a flowchart of an example method of aggregating captured data from a connected pet device.

FIG. 24 is a flowchart of an example method of determining health insights and correlating data that verifies the determined health insights.

### DESCRIPTION

The present disclosure relates to systems and methods of capturing and analyzing pet data using one or more connected devices. The platform allows a pet, such as a feline in some implementations, to use one or more connected pet devices, such as a primary pet device and/or a secondary pet device and the usage data is captured and provided to a pet device manager application that can identify various correlations, trends, behaviors, health insights, interventions, device settings, etc. In one example, the primary pet device may be a smart litterbox that has various sensors integrated into the litterbox, such as one or more weight sensors that can capture a weight value being borne by each of the sensors at different points on the litterbox. These weight values can allow the feline (or other pet) to be tracked as the feline approaches and initially enters the litterbox, how the feline moves around the litterbox and/or the duration of the visit, and what is left behind as the feline leaves the litterbox. The weight data can be sent to the pet device manager and using the data, the pet device manager can identify different cats using the litterbox based on the weights that are present in the data. In some implementations, this allows the pet device manager to track different of the litterbox any additional external tracking mechanism. This data can be further analyzed to determine if there are any issues present, such as a delay between expected visits by a particular cat to the litterbox, changes in behavior compared to historical data of that feline or aggregated data of other felines with similar characteristics, etc. This delay may indicate either non-usage of the litterbox, a health issue, or some other change in behavior. The pet device manager can then provide that identified delay to a pet owner or other user, such as a veterinarian, for early intervention into any inferred or determined health issues based on the captured sensor data.

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

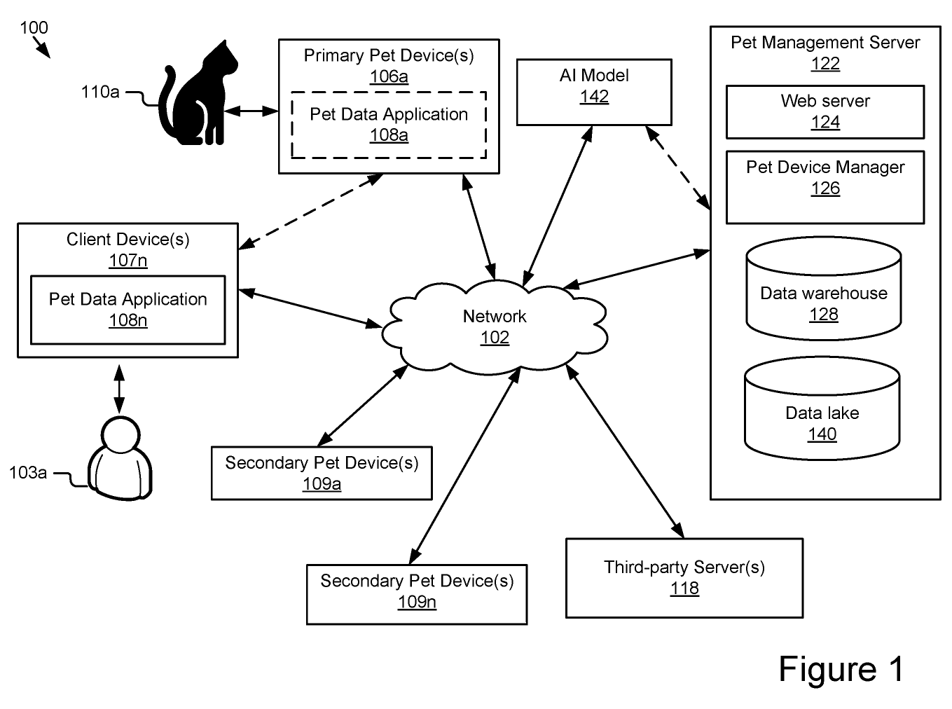

FIG. 1 is a block diagram of an example system 100 for systems and methods of capturing and analyzing pet data using one or more connected devices. The pet data may be associated with a specific pet 110. In some implementations, the pet 110 may be a feline or cat and the term “pet” or “cat” can be used interchangeably throughout the description and examples herein. Additionally, in other embodiments, the pet 110 may be contemplated to be a dog, bird, reptile, insect, fish, amphibian, horse, goat, cow, sheep, pig, or other relevant pet, etc. The illustrated system 100 may include one or more primary pet devices 106a-106n, one or more client devices 107n, one or more secondary pet devices 109n, a third-party server 118, a pet management server 122, and/or an AI model 142. In some implementations, the primary pet devices 106a-106n may run instances of a pet data application 108a…108n and which may be electronically communicatively coupled via a network 102 for interaction with one another, although other system configurations are possible including other devices, systems, and networks. In some implementations, the web server 124 may run instances of the pet device manager 126 and which may be electronically coupled via the network 102 to the primary pet device 106, client devices 107, and/or the third-party servers 118. For example, the system 100 could include any number of primary pet devices 106, client devices 107, third-party servers 118, secondary pet devices 109n, pet management server(s) 122, and other systems and devices.

The network 102 may include any number of networks and/or network types. For example, the network 102 may include, but is not limited to, one or more local area networks (LANs), wide area networks (WANs) (e.g., the Internet), virtual private networks (VPNs), wireless wide area networks (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols. The network may be able to determine identities of one or more other devices connected to the network 102 and provide identifies of the one or more other devices connected to the network 102 to the pet management server 122.

The primary pet device(s) 106 may include one or more smart connected pet devices that may be used by an animal, such as a smart litterbox, a smart water dispenser, a smart food dispenser, a smart video capture device, a smart tracking device, a smart toy, etc. These smart connected pet devices may couple to and communicate with other client devices 107 and the other entities of the system 100 via the network 102 using a wireless and/or wired connection, such as the pet management server 122, the pet device 109, and/or the third party server(s) 118. The smart connected pet devices may include various sensors (not shown) to capture different data related to the pets/users of the devices. For example, a smart litter box may include weight sensors, image sensors (such as cameras or LIDAR), pressure sensors, infrared sensors, RFID sensors, proximity sensors, other optical sensors, etc. that can capture data and provide it to the pet device manager 126. In another example, a smart food dispenser could include one or more weight sensors, image sensors (such as cameras and/or LIDAR), pressure sensors, accelerometers, proximity sensors, etc. that can capture an interaction of a pet eating or interacting with food from a dispenser.

The client device(s) 107 (e.g., multiple client devices 107 may be used by a single participant, multiple participants, stakeholders, or by other users) include one or more computing devices having data processing and communication capabilities. The client device 107 may couple to and communicate with other client devices 107 and the other entities of the system 100 via the network 102 using a wireless and/or wired connection, such as the pet management server 122, the primary pet device 106, the secondary pet device 109, and/or the third party server(s) 118. Examples of client devices 107 may include, but are not limited to, mobile phones, wearables, tablets, laptops, desktops, netbooks, server appliances, servers, virtual machines, TVs, etc. The system 100 may include any number of client devices 107, including client devices 107 of the same or different type.

In some implementations, one or multiple primary pet devices 106 and/or client devices 107 may be used with a pet data application 108. The pet data application 108 may receive various captured data from the pet device 106 or 109 and may present the pet data to the pet device manager 126 for further review of the pet data.

The pet management server 122 and its components may capture various pet data from the sensors of the pet devices 106, 109, and/or the third party server(s) 118 and analyze that data for various trends and identifiers, such as health insights, pet identities, pet behavior, health models, food palatability, boredom, food desirability, care recommendations, etc. These trends can then be provided to other components of the system 100 as needed.

One or more third-party servers 118 may be communicatively coupled with a primary pet device 106, client device 107, pet management server 122, secondary pet device 109, and/or network 102. For example, a third-party server 118 may connect the pet device manager 126 to a veterinarian service or other health provider if the pet data analyzed by the pet device manager 126 indicated a potential health problem. In another example, the third-party server 118 may connect the pet device manager 126 to a pet food company's database to provide insights about various pet food or other pet observations based on the data captured by the sensors of the pet device 106.

One or more secondary pet device(s) 109 may be communicatively coupled with a primary pet device 106, a client device 107, pet management server 122, third-party server 118, and/or network 102. For example, a secondary pet device 109 may be an additional pet device used by a particular pet 110a along with the primary pet device 106a. In one example, the secondary pet device 109 may be a smart water dispenser that can track the amount of water being dispensed for a particular pet that is also being tracked using weight measurements in a smart litterbox, etc. In another example, the secondary pet device 109 may be a smart food dispenser that can track the amount of food being dispensed, how quickly the food is being eaten or other characteristics related to the pet’s interaction with the food, how much (e.g., a weight) of the food is being consumed by the pet, etc. In another example, the secondary pet device 109 may be a smart toy that can track interactions between the pet and the smart toy and determine various insights between the captured data from the interactions with the smart toy and the interactions with the smart litterbox (or another primary pet device 106, etc.).

The pet management server 122 may include a web server 124, a pet device manager 126, a data lake 140, and a data warehouse 128. In some configurations, the pet device manager 126 may be distributed over the network 102 on disparate devices in disparate locations or may reside in the same location. The primary pet device 106, client device 107a, and/or the pet management server 122 may each include an instance of the pet device manager 126 and/or portions/functionalities thereof. The client devices 107 may also store and/or operate other software such as an operating system, other applications, etc., that are configured to interact with the pet management server 122 via the network 102.

The pet management server 122 and/or the third-party server 118 have data processing, storing, and communication capabilities, as discussed elsewhere herein. For example, the servers 118 and/or 122 may include one or more hardware servers, server arrays, storage devices and/or systems, etc. In some implementations, the servers 118 and/or 122 may include one or more virtual servers, which operate in a host server environment.

The data warehouse 128 and/or the data lake 140 may be stored on one or more information sources suitable for storing and providing access to data. The data warehouse 128 and/or the data lake 140 may store data describing primary pet devices 106, client devices 107, secondary pet devices 109, user 103 profiles, instances of the pet data application 108, collected pet data, pet data insights, historical pet data for individual pets, historical pet data of other pets that can be compared to captured pet data for a specific pet, etc. In some implementations, data stored in the data warehouse 128 and/or the data lake 140 may include data that has been verified with a correlating data source to further enhance prediction of future events. For example, if the pet device manager 126 predicts that a pet is losing weight and needs to visit the veterinarian and a Google calendar connected as a third-party application provides information about an upcoming veterinarian visit, then the prediction that the pet needs to visit the veterinarian can be given greater weight. Meaning that when a prediction or determination is verified by correlating data, then that prediction or determination becomes more reliable and can be given greater weight in AI training models, etc.

A third-party server 118 can host services such as a third-party application (not shown), which may be individual and/or incorporated into the services provided by the pet management server 122. For example, the third-party server 118 may represent one or more item databases, forums, company websites, calendars, email, etc. For instance, a third-party server 118 may provide automatically delivered and processed data or other services. In some instances, when the pet device manager 126 is given permission to view third-party applications on the third-party server 118, the pet device manager 126 can use the third-party data to verify insights, predictions, or determinations with real-world support to provide sources of truth or verification to the insights, predictions, or determinations made by the pet device manager 126.

It should be understood that the system 100 illustrated in FIG. 1 is representative of an example system and that a variety of different system environments and configurations are contemplated and are within the scope of the present disclosure. For instance, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc.

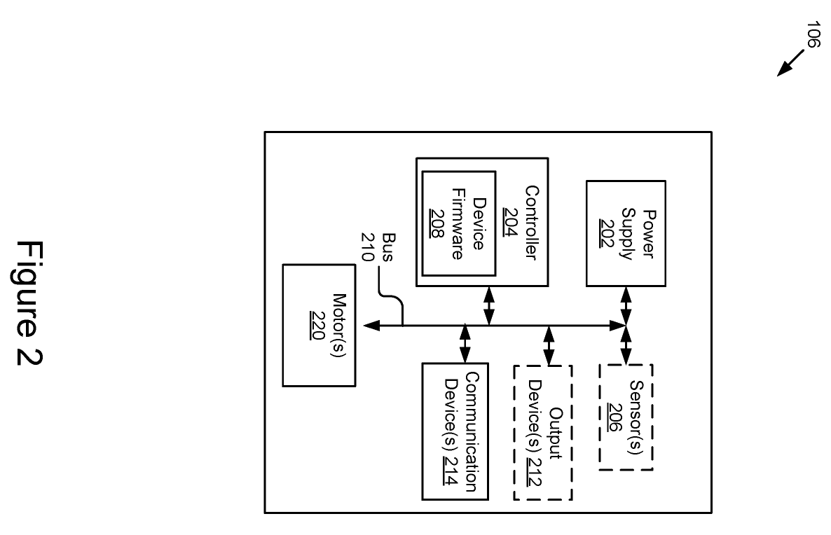

FIG. 2 is a block diagram illustrating an example primary pet device 106. In this instance, that primary pet device 106 may be an automatic litterbox device as an example of a primary pet device 106, which is depicted as including a power supply (PS) 202, one or more sensor(s) 206, a controller 204, output device(s) 212, device firmware 208, motor(s) 220 and/or communication device(s) 214. The components 202, 204, 206, 212, 220, and 214 are communicatively coupled via a communications bus 210. The controller 204 may include a non-transitory memory device, or may be coupled to a non-transitory memory device also coupled for communication via the bus 210. The non-transitory memory device may store software that specially configures the controller, such as the device firmware 208. The PS 202 may be any AC and/or DC power supply for powering the automatic litterbox. In some implementations, the PS 202 may be battery powered and may be configured to charge when plugged into an AC and/or DC power supply. The controller 204 may be a microchip that controls the constituent electronics (e.g., sensor(s) 206, output device(s) 212, communication device(s) 214, etc.) of the automatic litterbox device

The one or more sensor(s) 206 may include one or more pressure sensors, image sensors (such as a camera, LIDAR, infrared cameras, etc.), RFID sensors, light sensors, sound sensors (detecting yowling or other pet noises, etc.), temperature sensors (including temperature of a cat in the litterbox, as well as the temperature of waste left behind in a litterbox, etc.), pH sensors that could detect the pH of various waste, etc. for detecting a presence and/or additional details of an animal proximate to or using the automatic litterbox for waste disposal. These sensors may communicate various information about things detected by the sensor(s) 206 and provide that information to the controller 204 and/or separate remote devices, such as an automatic waste monitoring system (not shown) on a separate server, etc. These sensors 206 may capture sensor data, which may include weight changes or weight movements within the litterbox. For example, the sensors 206 may capture partial weights of the pet, such as a cat, the moment the cat begins to step into the device. This allows for the sensor(s) 206 to capture even the partial movements and the interactions that are even outside of the litterbox. Additionally, the sensor(s) 206 can capture the movements of the cat within the device, how long the cat is present in the litterbox, and/or what kinds of movements, such as pacing, circling, pawing, etc. were done by the cat within the litterbox. Over time, as sensor data is captured and attributed to the specific cat, a profile of that cat is built that shows how the cat generally interacts with the litterbox, such as time of day, duration, etc. When the pet device manager 126 detects changes in these behaviors, it may begin signaling to determine if the cat has a health problem or what other factors may have caused the cat to change behaviors (such as pulling from a calendar that a visitor was in town that changed the cat's behavior, etc.). It should be understood that in some implementations, more than just detecting weights of cats for identification, but detecting these behaviors and characteristics of each cat as they interact with the device, are what assist in determining cat identities over time.

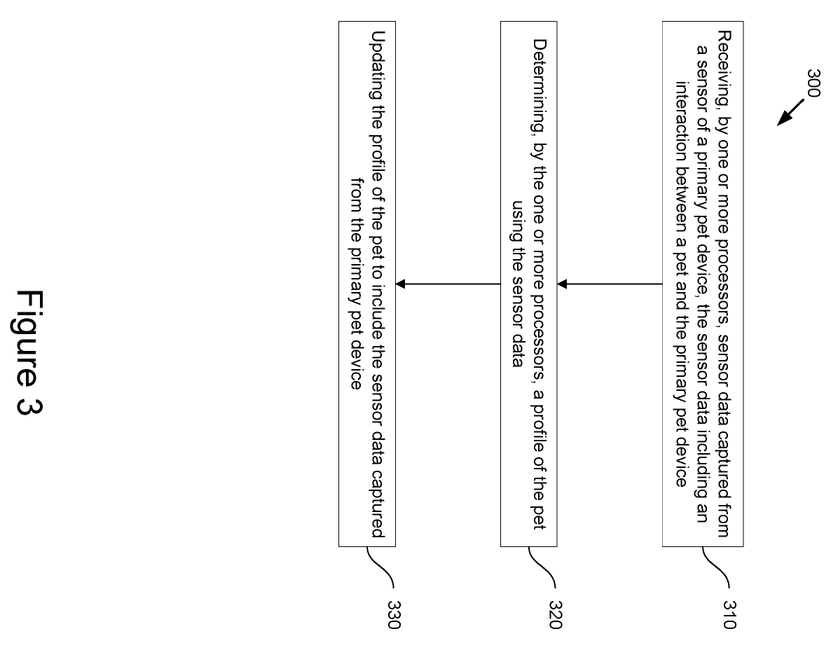

The communication device(s) 214 may include a transmitter or transceiver having a wireless interface configured to communicate with the devices coupled to a network (such as network 304 shown in FIG. 3) using standard communication protocols, such as Internet protocols. Further, the transceiver may be configured to wirelessly transmit data via a network to connect to other devices, such as a mobile device. By way of further example, the transceiver may transmit data to the mobile device to which it is linked using a protocol compliant with IEEE 802.15, such as Zigbee®, Z-Wave®, Bluetooth®, or another suitable standard. Further embodiments are also possible and contemplated. In some embodiments, the transceiver may be embedded in the controller 204 or may be a component distinct from the controller and coupled to the controller 204 via the bus 210.

The output device(s) 212 may further include one or more displays, light sources, sound sources, and/or audio reproduction devices, although further suitable output devices are also contemplated and applicable. In some implementations, the output device(s) 212 may be able to communicate various alerts, such as low power, error messages, passive refill status, etc. These output device(s) 212 may be able to quickly signal to a user a current state of the automatic litterbox and/or provide alerts if issues arise.

The motor(s) 220 may include one or more actuators that cause a tub of the litterbox to rotate about an axis point to cause waste within the tub to be sifted through a grate using gravity. These actuators may have various stopping and starting points to cause the tub to rotate consistently along the axis points and return to consistent positions after rotating. In some implementations, some of the sensors 206 may be weight sensors positioned at different points below the tub and/or LIDAR sensors positioned to look into the tub.

FIG. 3 is a flowchart of an example method 300 of identifying a profile of a pet using captured sensor data from the connected pet device. At block 310, the pet device manager 126 receives sensor data captured from a sensor 206 of a primary pet device 106, the sensor data including an interaction between a pet 110 and the primary pet device 106.

In some implementations, the pet 110 may be a feline, such as a cat. While other variations of pets are also contemplated. The primary pet device 106 may be an automatic litterbox as described elsewhere herein and the interaction between the cat and the automatic litterbox may be the cat moving into the automatic litterbox and leaving solid and/or liquid waste in the litterbox. The sensors 206 may include one or more weight sensors that can detect the weight being borne on each of the weight sensors. These weight sensors can provide the captured data at various points in time during the interaction to the pet device manager 126. The weight sensors can provide the weight individually and the pet device manager 126 can perform various computations to determine aggregated weights as it’s spread over the different weight sensors, how much weight was left behind (e.g. representing solid and/or liquid waste that remained in the litterbox, etc.).

At 320, the pet device manager 126 can determine a profile of the pet using the sensor data. The profile of the pet may be determined by first identifying a calculated weight of a cat that used the litterbox during the interaction. The calculated weight can be determined based on various sensor data provided by the different weight sensors. The pet device manager 126 may be able to view the sensor data from the weight sensors to determine when only a portion of the cat is in the litterbox (e.g., the cat is moving into the litterbox or out of the litterbox and only a portion of the cat’s weight is being captured while the rest of the weight rests outside of the litterbox, etc.). The pet device manager 126 may further be able to determine a weight of the cat after determining when the full weight of the cat is being read by the weight sensors. This full weight of the cat may include the weight of the cat, the weight of the tub with litter from the litterbox, and/or the weight of any solid and/or liquid waste left by the cat during the interaction with the litterbox. The pet device manager 126 can calculate those different weights, as well as how much litter was used to clean out the waste during a waste cycle on the litterbox, etc. After the weight is determined for the cat, the pet device manager 126 may then match the weight to various cat profiles. These cat profiles can have different cats with different historical weights for each of those cats. The pet device manager 126 can then match the current weight to the weights of the various cat profiles to match the current weight to a cat profile.

In some implementations, weight alone may not be able to provide enough differentiation between cats. For example, cats that are closely related in weight or cats with large weight changes could benefit from having further data that can be matched. Along with the weight, in some implementations, the pet device manager 126 can match one or more behaviors and/or characteristics that are observed in the sensor data. These behaviors of the cat during the interaction may include a time of day that the interaction is occurring, a length of time the interaction occurs, a movement of the cat within the litterbox (such as circling, pawing, or digging/covering the litter), a noise made by the cat during the interaction, known cats in a household, a weight of the waste remaining after the interaction, etc. These behaviors provide additional context that, along with the weight, can be compared from the current sensor data to historical behaviors associated with different cats in cat profiles. The pet device manager 126 can identify various behaviors that match within a certain threshold degree of accuracy between the current determined behaviors and historical behaviors in order to attribute the current behaviors and interaction to a specific cat and update that cat's profile. At 330, once the sensor data has been used to match with a cat profile, using at least one of the weight and/or the behaviors observed during the interaction with the litterbox, the pet device manager 126 can update the profile of the pet to include at least a portion of the captured sensor data, such as a measured weight, a measured waste weight, one or more of the determined characteristics, the times of various parts of the interactions, etc. By updating the profile to include at least a portion of the current sensor data, the pet device manager 126 can save various cat analytics to the cat profile for future comparison. The cat profile could then be analyzed, such as by the AI model 142 to determine various trends or behavioral analytics in order to identify health insights, recommendations, historical models, etc.

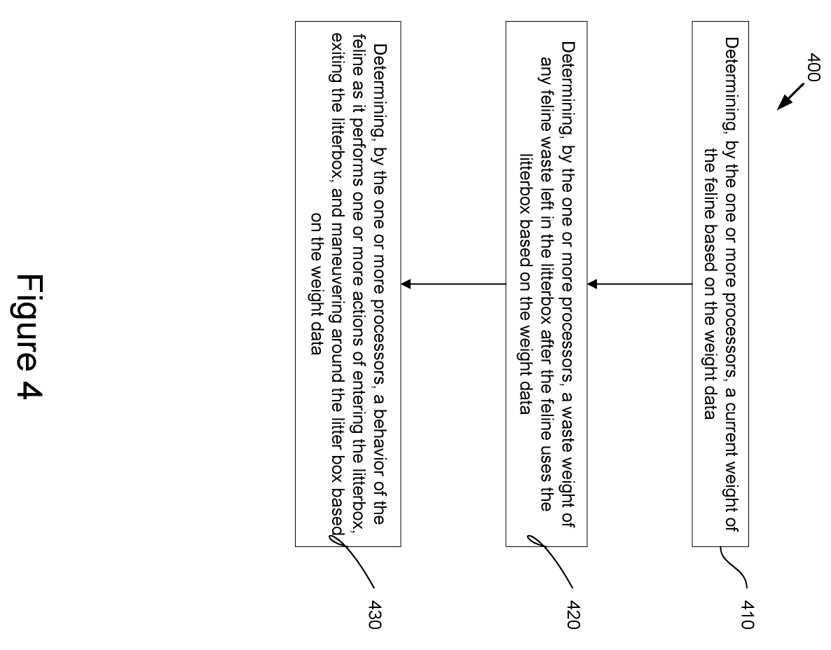

FIG. 4 is a flowchart 400 of an example method of determining a weight of a pet, waste weight of a pet, and/or behaviors of a pet using a connected pet device. At 410, the pet device manager 126 can determine a current weight of the feline based on the weight data. As described above with respect to FIG. 3, the weight sensors can be spread out over different parts of the litterbox and by analyzing that data of the weight borne by each of the weight sensors individually and then aggregating that data using the pet device manager 126, a weight of the cat can be determined.

At 420, along with determining the weight of the cat, the pet device manager 126 can determine a waste weight of any feline waste left in the litterbox after the feline uses the litterbox based on the weight data. The waste weight can include both solid weight and/or liquid weight based on the cat’s interaction with the litterbox. Additionally, in some implementations, the waste weight can also include how the profile of the waste weight changes over time as it dries out and becomes lighter.

At 430, the pet device manager 126 can determine a behavior of the feline as it performs one or more actions of entering the litterbox, exiting the litterbox, and maneuvering around the litterbox based on the weight data. As described elsewhere herein, the weight sensors can track various movement within the litterbox and characterize those movements as behaviors of the feline. Additionally, in some implementations, along with weight sensors, the litterbox can include other sensors like LIDAR cameras or infrared cameras to detect various features about the cat in the litterbox. The LIDAR cameras can capture the cat movement and when the cat leaves the litterbox. The infrared cameras could capture various temperatures showing how the heat map of the litterbox changes during an interaction between the cat and the litterbox.

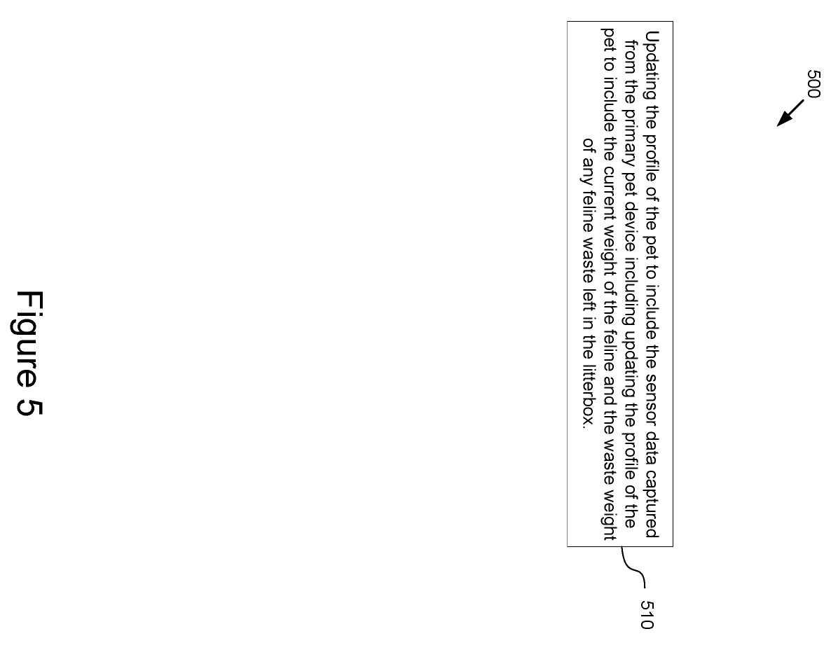

FIG. 5 is a flowchart 500 of an example method of updating a pet profile to include capturing sensor data from a connected pet device. At 510, the pet device manager 126 can update the profile of the pet 110 to include the sensor data captured from the primary pet device 106, including updating the profile of the pet to include the current weight of the feline and the waste weight of any feline waste left in the litterbox. As described elsewhere herein, the weight of the feline and the waste weight of the feline can be calculated and used for future analytics by the pet device manager 126.

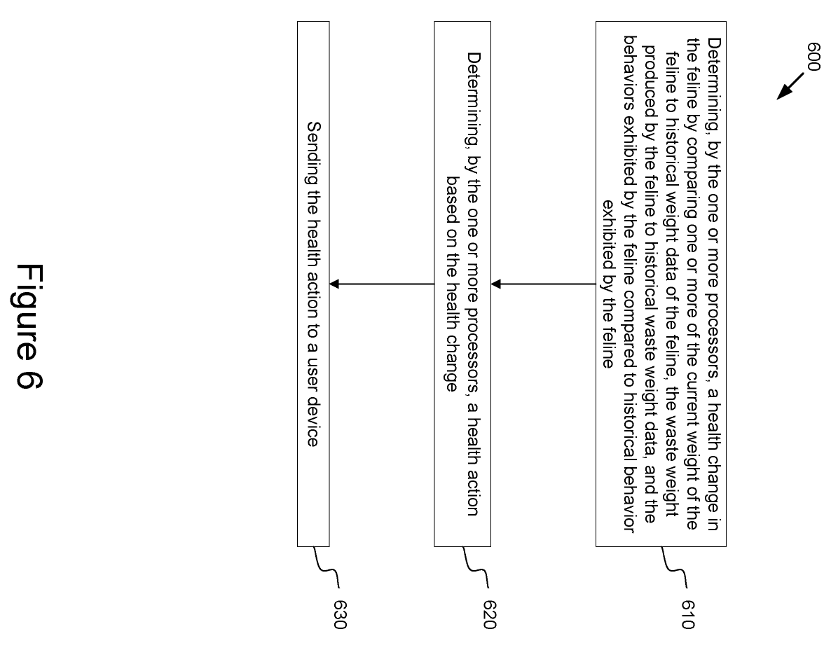

FIG. 6 is a flowchart 600 of an example method of determining a health change in a pet using captured sensor data from a connected pet device. At 610, the pet device manager 126 can determine a health change in the feline by comparing one or more of the current weight of the feline to historical weight data of the feline, the waste weight produced by the feline to historical waste weight data, and the behaviors exhibited by the feline compared to historical behavior exhibited by the feline. As described elsewhere herein, the health change can be a change detected from the captured sensor data. For example, a cat can be detected at a first weight during a first visit to the litterbox and/or this first weight can match with an expected first weight based on the characteristics of the cat, such as breed type, historical weight of that breed, previous weights of the specific cat, etc. At a later time, a second weight can be captured during a second visit by the cat to the litterbox. This second weight is then compared to the first weight to determine any weight insights, such as if the weight has increased or decreased beyond a normal range for that cat. If the weight has changed significantly, a health action could be determined based on the data.

In another example, the waste weight of the cat can be captured from the sensor data and compared to previous waste weight of that specific cat and/or historical cat waste weight data of cats that have similar profiles (e.g., similar size, breed, characteristics, etc.). If there is a change in the amount of waste weight or if the waste weight does not follow an expected pattern over a period of time, then the pet device manager 126 can determine a health action as described elsewhere herein.

In another example, the behaviors of the cat can be determined from the sensor data and compared to previous behaviors of the cat and/or historic cat behavior data based on cats that have similar profiles from a plurality of cats, (e.g., similar size, breed, characteristics, etc.). If there is an unexpected behavior or a trend/change in a behavior that deviates from what is expected, then the pet device manager 126 can determine a health action.

At 620, the pet device manager 126 can determine a health action based on the health change. The health change can be any deviation from an expected weight, waste weight, or behavior of a specific cat compared to either previous data of that specific cat or historical data of other similar cats. The deviation or change can be tracked by the pet device manager 126 and when the change exceeds a threshold value, the pet device manager 126 can begin to automatically determine a health action based on the change. For example, in one implementation, a decrease in weight, waste weight, or behavior can indicate that a cat is sick and the pet device manager 126 can at 630 send a health action to the user device, such as an alert that the cat may be ill, that the cat has decreased weight, that the cat should potentially visit a veterinarian, that a water feeder or food feeder should be checked to make sure there are no issues with food or water, etc. In some implementations, the pet device manager 126 can further correlate data with third-party applications from the third-party server 118 and/or the secondary pet device 109 to further verify various health actions and further diagnose potential problems. As the database of information from various pet interactions grows from captured sensor data, the pet device manager 126 can compare the various changes, such as health changes or behavior changes, to the database of other pet interactions and/or corresponding third-party data that verifies the information and provide more insightful health actions over time as that database of various health actions and/or diagnoses grows. Essentially, as the database grows, the pet device manager 126 can compare captured symptoms from the sensor data to correlating symptoms and health actions of other pets from the database and identify previous actions that were successful and use those previous actions as potential health action recommendations for the current pet based on the captured symptoms.

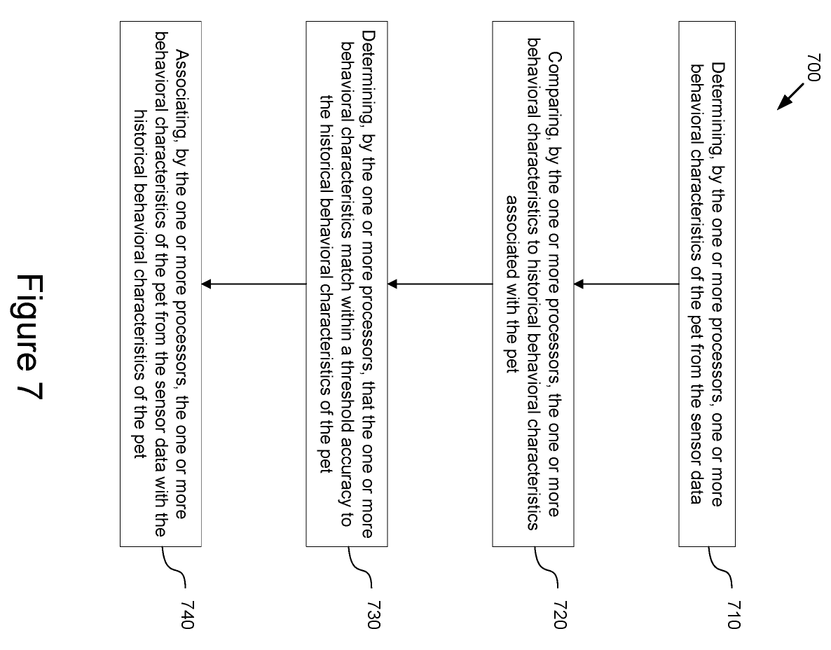

FIG. 7 is a flowchart of an example method 700 of determining an identity of a pet using determined pet behaviors. At 710, the pet device manager 126 determines one or more behavioral characteristics of the pet from the sensor data. The behavioral characteristics may be actions taken by the pet, such as a cat. The actions may be how the cat enters and/or exits the primary pet device 106, how the cat interacts with both a primary pet device 106 and/or a second pet device 109 over a period of time, such as when a cat eats from a pet feeder and then leaves waste in the litterbox, etc. The actions may further demonstrate how the cat moves around in the primary pet device 106, any noises or rubbing/interactions done within the primary pet device, any unexpected actions taken during the interaction with the primary pet device 106, etc.

At 720, the pet device manager 126 can compare the one or more behavioral characteristics to historical behavioral characteristics associated with the pet. The historical behavior characteristics can either be previously captured behavioral characteristics of that specific pet, such as how the pet initially used the primary pet device 106, how long the pet generally uses the pet device 106/109, etc. In further implementation, the pet device manager 126 can also compare the behavioral characteristics to aggregated pet data from a plurality of other pets that have similar traits to the current pet. For example, cats of the same breed, similar weights, and/or similar behavioral characteristics that have been compared over time can be considered a subset of the plurality of cats and the historical behavioral data of this subset of the plurality of cats can be compared to the behavioral characteristics from the currently captured sensor data. At 730, the pet device manager 126 can determine that the one or more behavioral characteristics match within a threshold accuracy to the historical behavioral characteristics of the pet and/or at least a portion of the subset of historical behavioral data of the subset of the plurality of cats. Based on this matching, at 740, the pet device manager 126 can associate the one or more behavioral characteristics of the pet from the sensor data with the historical behavioral characteristics of the pet. This may include updating a pet profile to include at least a portion of the captured sensor data and/or any determinations made by the pet device manager 126 based on the captured sensor data.

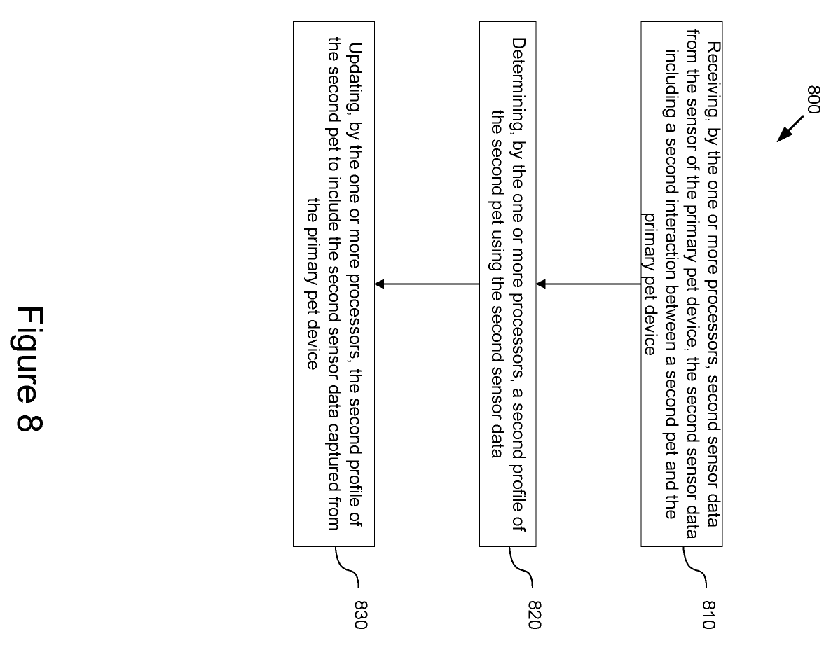

FIG. 8 is a flowchart of an example method 800 of multi-pet identification using captured sensor data from a connected pet device. At 810, the pet device manager 126 can receive second sensor data from the sensor of the primary pet device 106, the second sensor data including a second interaction between a second pet 110b and the primary pet device 106. For example, a primary pet device 106 may be used by multiple cats, (e.g., a first pet 110a and a second pet 110b). These cats may in some instances have slightly different weights and/or behaviors that can be detected in the captured sensor data. At 820, the pet device manager 126 can determine a second profile of the second pet 110b using the second sensor data. The pet device manager 126 is able to differentiate between two different cats without any intervention by a user or any specific hardware being worn by each of the cats. This allows for the pet device manager 126 to automatically track various pet behaviors and/or interactions with the smart pet devices 106/109 without any user intervention, actions, or specialized hardware. Additionally, this determination of different pets/cats using the primary pet device 106 can be done without any potentially invasive privacy issues, such as cameras that are pointed in a direction that capture areas surrounding the pet device. Using the combination of weight sensors and/or other sensors (such as LIDAR to determine if a cat is clear of the litterbox for a waste cycle, etc.) the pet device manager 126 can automatically make these determinations of which pet to associate captured sensor data to. Additionally, even if different cats have similar/identical weights, by also capturing the behaviors of the different cats as they interact with the litterbox, the pet device manager 126 can further differentiate the different cats based on the behaviors along with the captured weights. Once the profile of the pet has been identified, at 830, the pet device manager 126 can update the profile of the second pet to include the second sensor data captured from the primary pet device and/or any determinations made by the pet device manager 126 based on the captured sensor data.

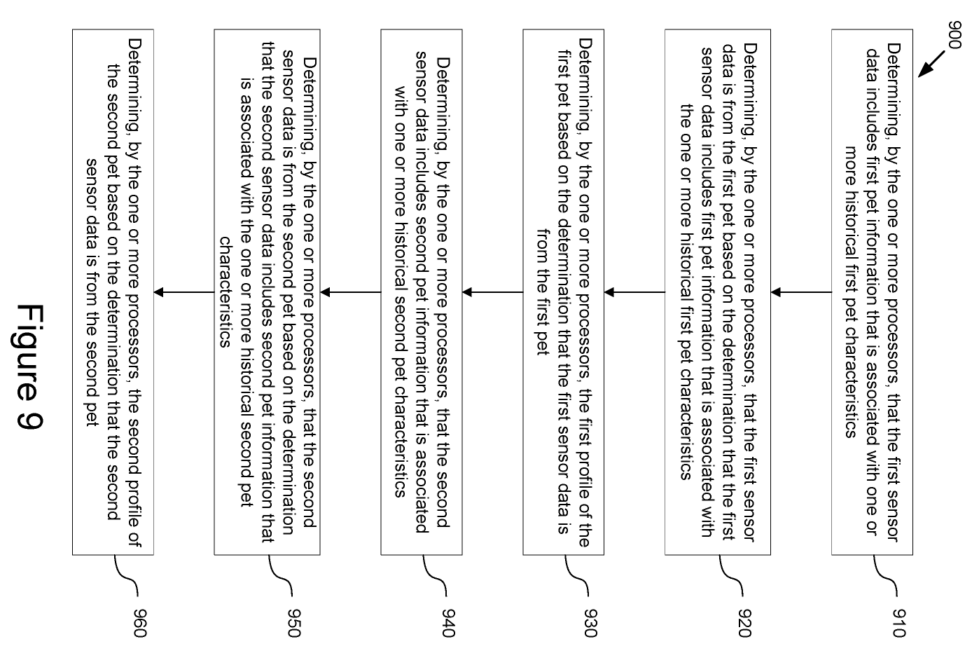

FIG. 9 is a flowchart of an example method 900 of multi-pet identification using capture sensor data from a connected pet device. At 910, the pet device manager 126 can determine that the first sensor data includes first pet information that is associated with one or more historical first pet characteristics. This allows for multi-pet identification where the first pet information can be attributed to the first cat, such as at 920, where the pet device manager 126 determines that the first sensor data is from the first pet 110a based on the determination that the first sensor data includes first pet information that is associated with the one or more historical first pet characteristics as described elsewhere herein. At 930, the pet device manager 126 can then determine the first profile of the first pet based on the determination that the first sensor data is from the first pet.

At 940, the pet device manager 126 can then determine that the second sensor data includes second pet information that is associated with one or more historical second pet characteristics. This allows for the pet device manager 126 to separate out and attribute different sensor data to different cats as they use the litterbox. In some examples, the pet device manager 126 could even determine when the litterbox is being interacted with by multiple cats simultaneously and map out which behaviors and/or interactions are associated with which cats, etc. At 950, the pet device manager 126 can determine that the second sensor data is from the second pet 110b based on the determination that the second sensor data includes second pet information that is associated with the one or more historical second pet characteristics as described elsewhere herein. At 960, the pet device manager 126 can then determine the second profile of the second pet based on the determination that the second sensor data is from the second pet 110b.

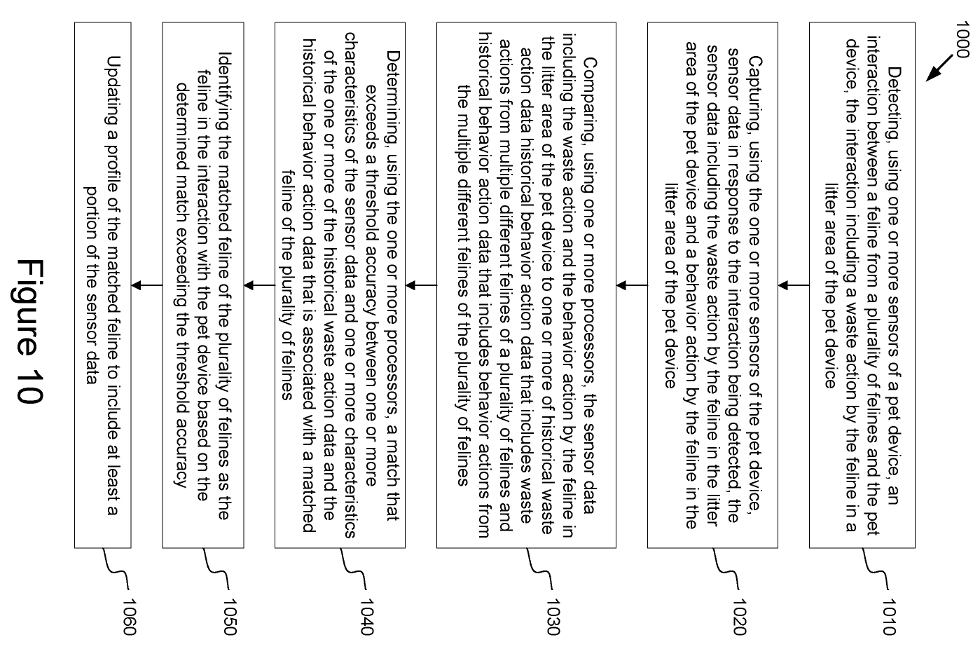

FIG. 10 is a flowchart of an example method 1000 of comparing captured pet data to historical data in order to identify one or more pets from the captured sensor data of a connected pet device. At 1010, the pet device manager 126 can detect an interaction between a feline from a plurality of felines and the pet device, the interaction including a waste action by the feline in a litter area of the pet device. The detection of the interaction can be done by analyzing the sensor data and determining which actions map to historical data that correlates to those actions, such as a first weight sensor indicating that a cat has stepped into a litterbox area, and/or a second weight sensor indicating that the cat has fully moved into the litterbox area. These historical patterns of the movements of the cat within the litterbox area can be used to map a current interaction from a cat within the litterbox area using just the plurality of weight sensors, and/or additional sensors.

At 1020, the pet device manager 126 can capture, using the one or more sensors of the pet device, sensor data in response to the interaction being detected, the sensor data including the waste action by the feline in the litter area of the pet device and a behavior action by the feline in the litter area of the pet device. In some implementations, the capturing of the sensor data may be done automatically when a sensor detects a presence of a cat, etc. At 1030, the pet device manager 126 can compare the sensor data including the waste action and the behavior action by the feline in the litter area of the pet device to one or more of historical waste action data and historical behavior action data that includes waste actions from multiple different felines of a plurality of felines and historical behavior action data that includes behavior actions from the multiple different felines of the plurality of felines as described elsewhere herein. At 1040, the pet device manager 126 can determine a match that exceeds a threshold accuracy between one or more characteristics of the sensor data and one or more characteristics of the one or more of the historical waste action data and the historical behavior action data that is associated with a matched feline of the plurality of felines as described elsewhere herein. At 1050, the pet device manager 126 can identify the matched feline of the plurality of felines as the feline in the interaction with the pet device based on the determined match exceeding the threshold accuracy and at 1060, the pet device manager 126 can update a profile of the matched feline to include at least a portion of the sensor data.

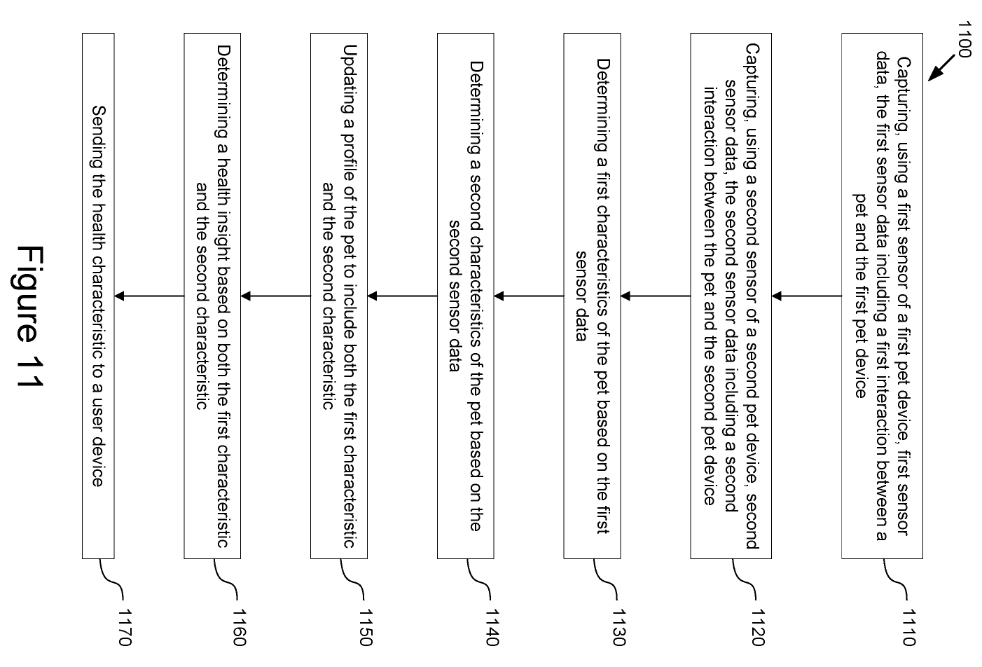

FIG. 11 is a flowchart of an example method 1100 of identifying health insights from determined characteristics of one or more pets. At 1110, the pet device manager 126 can capture, using a first sensor of a first pet device, first sensor data, the first sensor data including a first interaction between a pet 110 and the first pet device, such as primary pet device 106. At 1120, the pet device manager 126 can capture, using a second sensor of a second pet device, second sensor data, the second sensor data including a second interaction between the pet and the second pet device, such as a secondary pet device 109. For example, the primary pet device 106 may be an automatic litterbox used by a cat and the secondary pet device 109 may be a pet feeder used by the cat. At 1130, the pet device manager 126 can determine a first characteristic of the pet based on the first sensor data. In the example, the first characteristic may include a weight determination, a waste weight determination, a behavior determination, etc. as the cat uses the automatic litterbox. At 1140, the pet device manager 126 can determine a second characteristic of the pet based on the second sensor data. In the example, the second characteristic may include a weight/quantity of food eaten by the cat at the pet feeder, a speed at which the cat consumed the food, any interactions the cat performs while eating the food, such as coming and going, batting at the food, etc. At 1150, the pet device manager 126 can update a profile of the pet to include both the first characteristic and the second characteristic. It should be further understood that in a multi-cat embodiment, the pet device manager 126 can also determine which cat used the litterbox and/or the feeder from the captured sensor data and attribute different characteristics to the different cats that are stored in the cat profiles. At 1160, the pet device manager 126 can then determine a health insight based on both the first characteristic and the second characteristic as described elsewhere herein. These health insights can be determined by comparing characteristics to aggregated pet data from other pets with similar profiles and/or by comparing the characteristics to historical data of the current pet for changes or trends. At 1170, the pet device manager 126 can send the health characteristics to a user device 107.

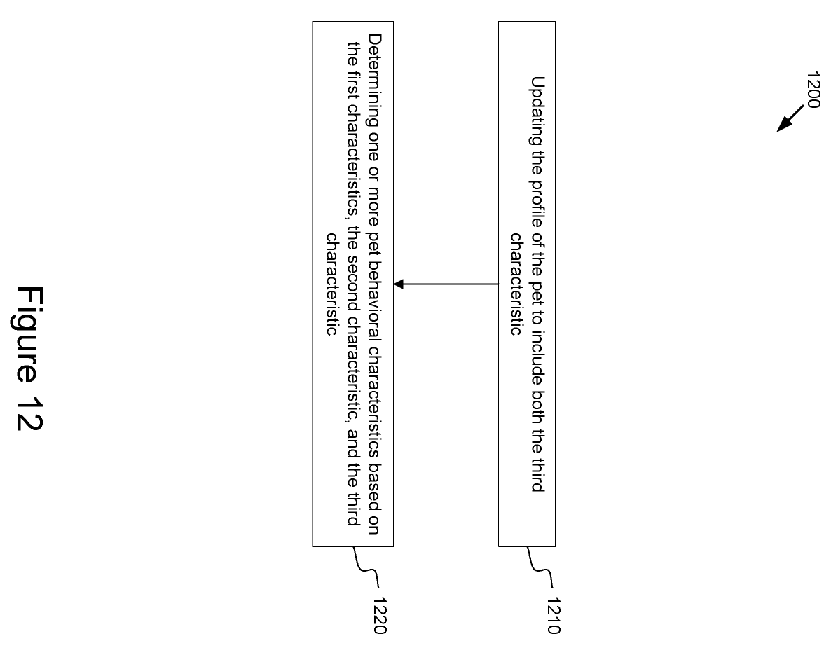

FIG. 12 is a flowchart of an example method 1200 of determining pet behavioral characteristics. With respect to the embodiment described in FIG. 11, the pet device manager 126 can further determine one or more third characteristics, such as from a third pet device interaction, such as a water feeder, etc. At 1210, the pet device manager 126 can update the profile of the pet to include both the third characteristics, as well as the first and second characteristics. At 1220, the pet device manager 126 can determine one or more pet behavioral characteristics based on the first characteristics, the second characteristic, and the third characteristic as described elsewhere herein. The third characteristic provides an additional data point for further analysis and determinations, such as determining characteristics, health insights, trends, behavior changes, etc. For example, the first characteristic may be associated with an interaction with a litterbox, the second characteristic may be associated with an interaction with a pet feeder, and the third characteristic may be associated with an interaction with a pet water feeder. Those three interactions can provide different characteristics that the pet device manager 126 can use to determine various health insights or behavioral trends as data is collected.

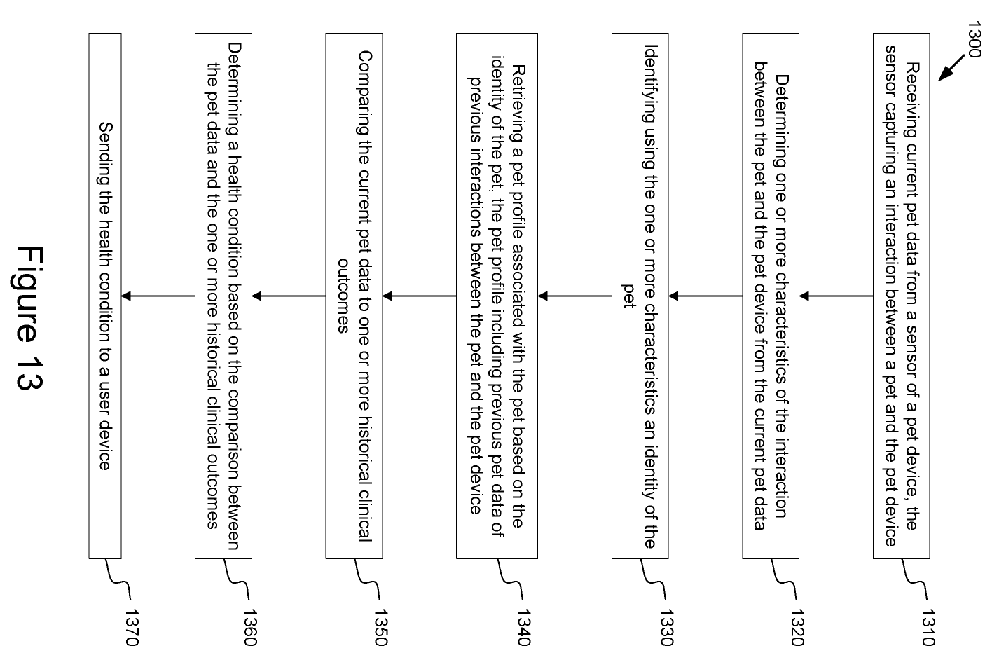

FIG. 13 is a flowchart of an example method 1300 of determining a health condition of a pet using characteristics of an interaction between the pet and a connected pet device. At 1310, the pet device manager 126 can receive current pet data from a sensor of a pet device, the sensor capturing an interaction between a pet and the pet device. At 1320, the pet device manager 126 can determine one or more characteristics of the interaction between the pet and the pet device from the current pet data as described elsewhere herein. At 1330, the pet device manager 126 can identify, using the one or more characteristics, an identity of the pet and/or a corresponding pet profile associated with that pet based on the identity as described elsewhere herein. At 1340, the pet device manager 126 can retrieve a pet profile associated with the pet based on the identity of the pet, the pet profile including previous pet data of previous interactions between the pet and the pet device. At 1350, the pet device manager126 can compare the current pet data to one or more historical clinical outcomes. These historical clinical outcomes may include aggregated pet data from other pets with similar profiles/characteristics, and the historical clinical outcomes may include potential health actions taken based on health changes detected in the sensor data and results of the health actions that were taken. Such as detecting a change in waste frequency, triggering a vet visit that a vet was able to use to diagnose an illness in a cat, etc. At 1360, the pet device manager 126 can compare the current pet data to one or more historical clinical outcomes and identify potential clinical outcomes that could be used for the current pet based on the historical data. In other implementations, the historical clinical outcomes may instead include pet data specific to the current pet, such as previous interventions for that pet and results of those interventions. For example, a specific cat may have a bladder stone issue that occurs frequently, and the sensor data can be used to detect various warning signs, such as noises made during urination, blood in the urine (such as from a pH sensor, image sensor, etc.), and/or just multiple urination actions being taken over a short period of time, which may indicate an issue. Based on the historical actions of just that cat, a health intervention can be recommended when the symptoms match up to similar previous symptoms. At 1370, the pet device manager 126 can send the health condition to a user device.

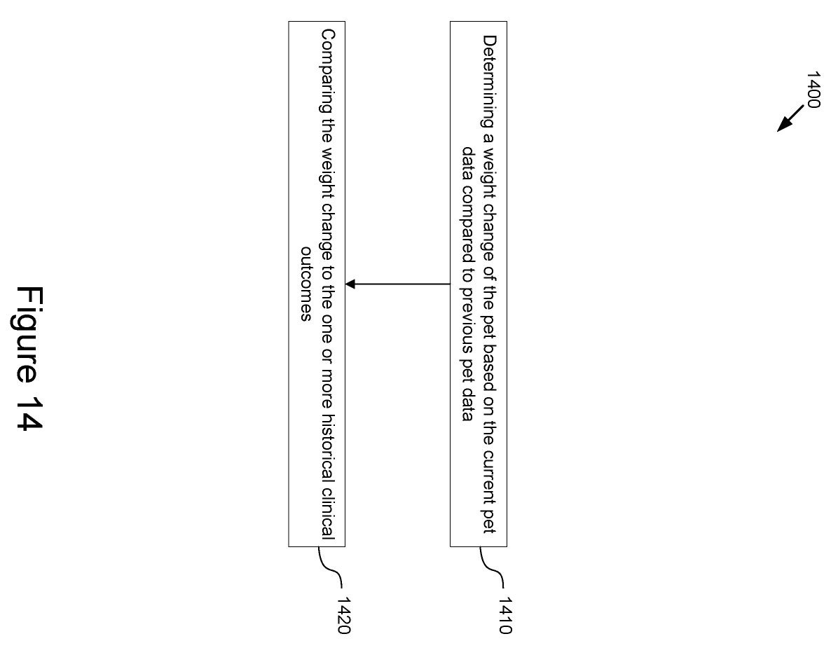

FIG. 14 is a flowchart of an example method 1400 of determining weight changes of one or more pets. At 1410, the pet device manager 126 can determine a weight change of the pet based on the current pet data compared to previous pet data as described elsewhere herein. At 1420, the pet device manager 126 can compare the weight change to the one or more historical clinical outcomes as described elsewhere herein. Based on those comparisons, the pet device manager 126 can determine one or more health insights, interventions, behavioral changes, etc.

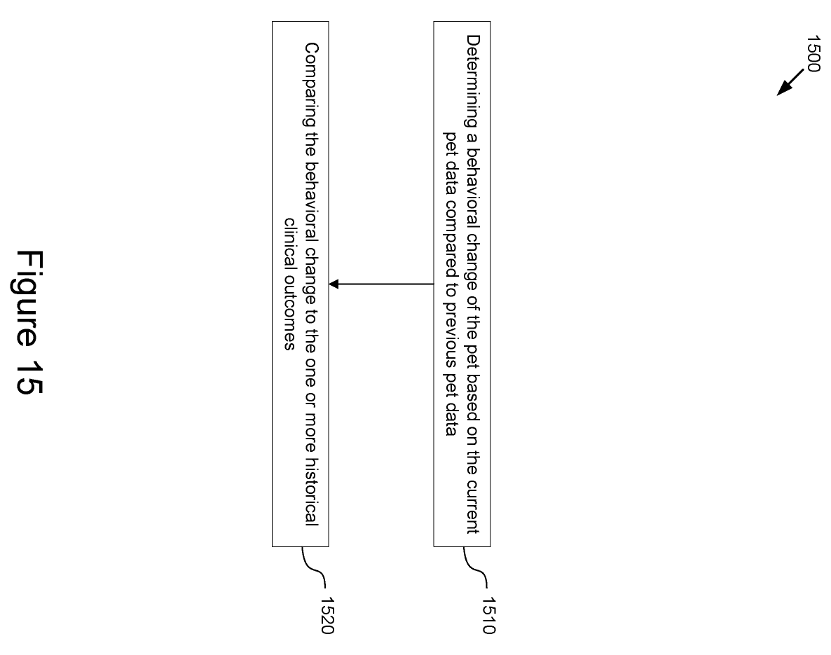

FIG. 15 is a flowchart of an example method 1500 of determining behavioral changes of one or more pets. At 1510, the pet device manager 126 can determine a behavioral change of the pet based on the current pet data compared to previous pet data as described elsewhere herein. At 1520, the pet device manager 126 can compare the behavioral change to the one or more historical clinical outcomes as described elsewhere herein. Based on those comparisons, the pet device manager 126 can determine one or more health insights, interventions, behavioral changes, etc.

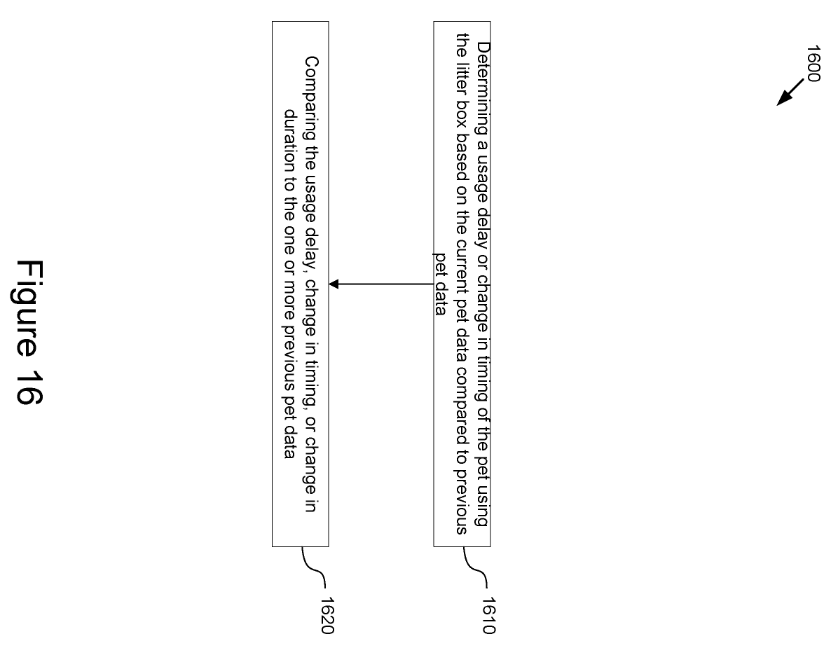

FIG. 16 is a flowchart of an example method 1600 of determining a change in usage of a connected pet device. At 1610, the pet device manager 126 can determine a usage delay or change in timing of the pet using the litter box based on the current pet data compared to previous pet data as described elsewhere herein. At 1620, the pet device manager 126 can compare the usage delay, change in timing, or change in duration to the one or more previous pet data that may be stored in a database and accessible by the pet device manager 126. By comparing the usage delay, change in timing, change in duration, etc. to the previous pet data, various insights can be determined by the pet device manager 126 as described elsewhere herein.

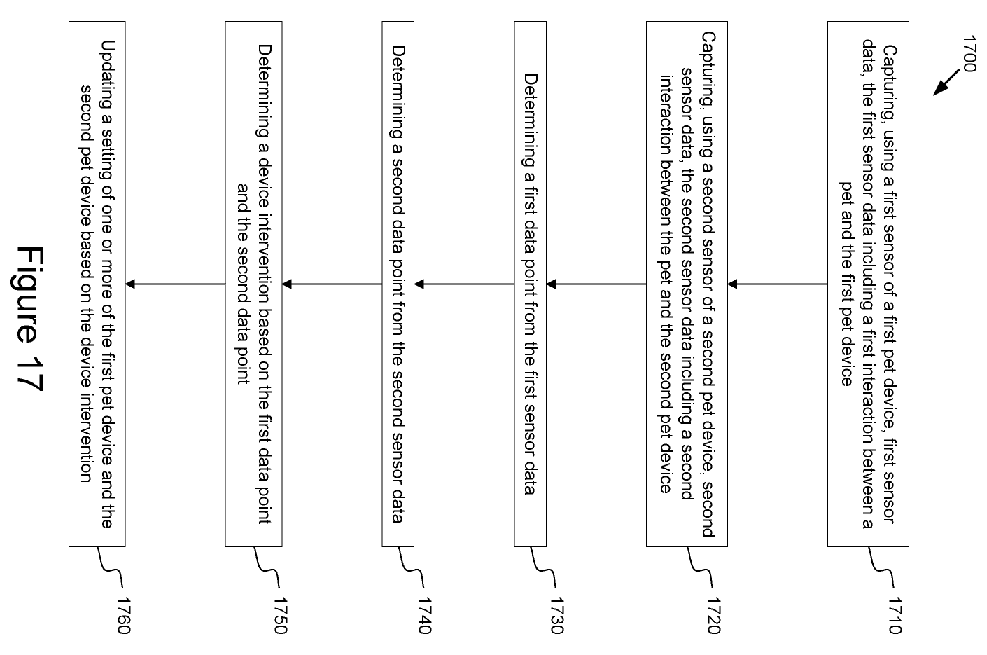

FIG. 17 is a flowchart of an example method 1700 of determining a device intervention based on captured sensor data from a connected pet device. At 1710, the pet device manager 126 can cause a first sensor to capture first sensor data, the first sensor data including a first interaction between a pet and the first pet device as described elsewhere herein. At 1720, the pet device manager 126 can cause a second sensor to capture second sensor data, the second sensor data including a second interaction between the pet and the second pet device as described elsewhere herein. At 1730, the pet device manager 126 can determine a first data point from the first sensor data. The first data point can be any of the previously described data derived from the sensor data, such as a weight, a behavior, etc. At 1740, the pet device manager 126 can determine a second data point from the second sensor data as described elsewhere herein. The second data point can be any of the previously described data derived from the sensor data, such as a weight, a behavior, etc. At 1750, the pet device manager 126 can determine a device intervention based on the first data point and the second data point. For example, in one implementation, the first pet device can be a litterbox and the second pet device can be an automatic feeder. The second data point can be one or more of a speed at which a pet consumes pet food from the device, an interest/boredom level determined based on the behavior with the pet food from the device, etc. The first data point can be waste weight and/or timing of waste actions by the pet. The pet device manager 126 can compare the first and second data points to expected pet data and determine that the pet appears to be less interested in the food, such as reaching a boredom level with the food and the device intervention can be to change the food from the pet feeder. For example, the pet feeder may have multiple storage areas for different types of pet food, such as a fish pet food and/or a lamb pet food and the device intervention can be to switch the pet food from fish to lamb. In another example, the pet device manager 126 could determine based on a quantity of food being consumed and amount of weight being measured when the cat is in the litterbox that the cat is exceeding a recommended weight and the pet feeder can reduce the quantity of food being dispensed. In another example, the device intervention could be to change a subscription schedule of pet food, such as switching from a first pet food to a second pet food to address a boredom/interest level or a health action such as to gain or lose weight of the pet. This rotation to a different food in the subscription setting of the pet data application 108 can be performed automatically, without user intervention, to address one or more needs of the cat or interest changes of the cat. At 1760, the pet device manager 126 can update a setting of one or more of the first pet device and the second pet device based on the device intervention as described above.

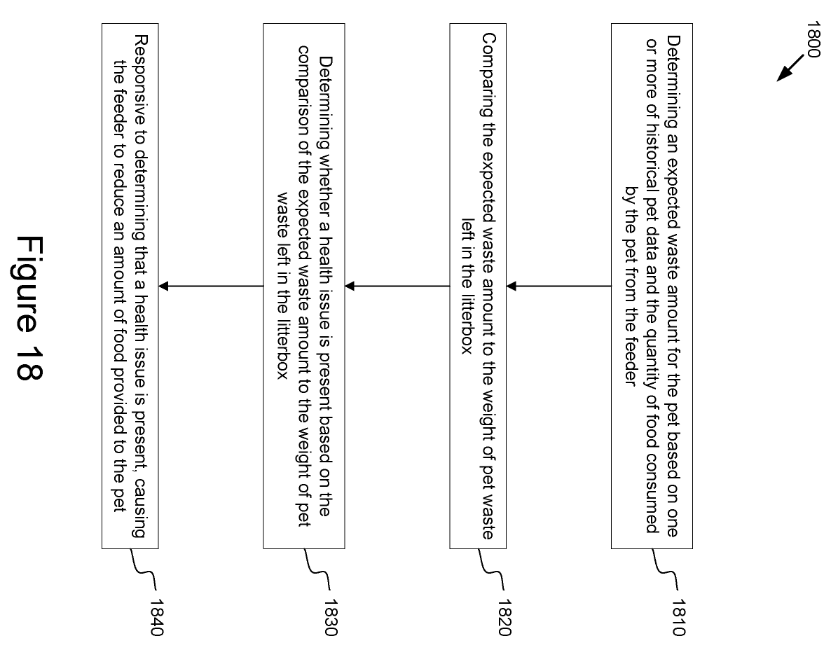

FIG. 18 is a flowchart of an example method 1800 of determining a health issue based on captured sensor data from a connected pet device. At 1810, the pet device manager 126 can determine an expected waste amount for the pet based on one or more of historical pet data and the quantity of food consumed by the pet from the feeder. At 1820, the pet device manager 126 can compare the expected waste amount to the weight of pet waste left in the litterbox and determine if it exceeds an expected value or is less than an expected value based on both the historical pet data and the expected value based on the amount of food consumed from the feeder. At 1830, the pet device manager 126 can determine whether a health issue is present based on the comparison of the expected waste amount to the weight of pet waste left in the litterbox as described elsewhere herein. For example, if the observed waste is lower than expected and the observed food consumption is lower than expected, then the cat may be exhibiting symptoms of an illness. In another example, if the observed food consumption is high and the observed weight of the cat in the litterbox is higher than expected, then the pet device manager 126 may determine that a weight-gaining issue is present and reduce the amount of food being dispensed and/or switch to a diet food, etc. At 1840, the pet device manager 126 can determine that a health issue is present and cause the feeder to reduce an amount of food provided to the pet.

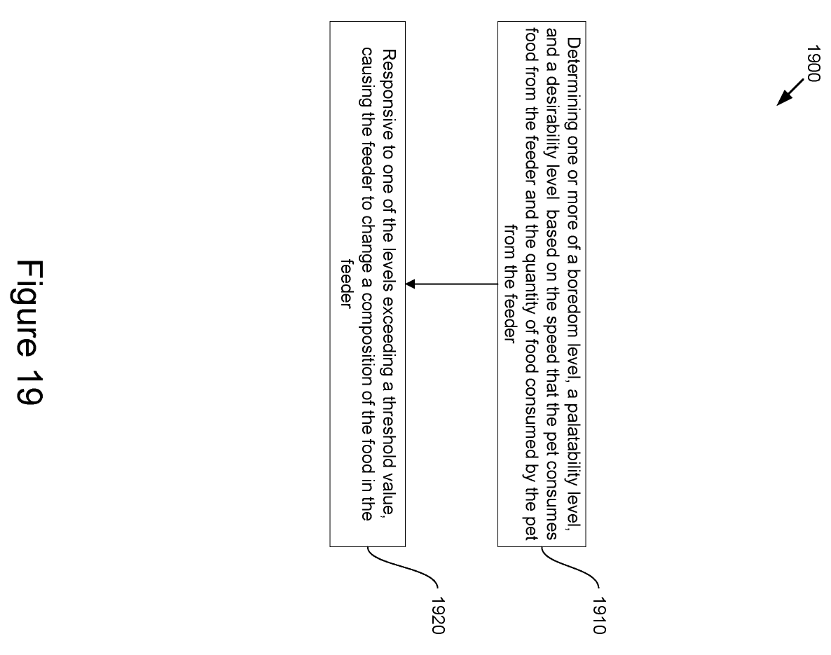

FIG. 19 is a flowchart of an example method 1900 of determining one or more of a boredom level of a pet, a palatability level of a food consumed by a pet, and a desirability of a food consumed by a pet. At 1910, the pet device manager 126 can determine one or more of a boredom level, a palatability level, and a desirability level based on the speed at which the pet consumes food from the feeder and the quantity of food consumed by the pet from the feeder. The boredom level may be an indication of when a pet, such as a cat, is interested in the food. If the cat is excited by the food, then it will likely consume the food faster and not leave any food behind. Over time, as the cat becomes bored with the current food, the pet device manager 126 may observe a slower eating pace as the food is less interesting and/or the cat may start leaving food behind and/or grazing on the food over time instead of quickly consuming the food. The pet device manager 126 can generate boredom levels that represent scores of how interested the cat is in the food currently, and the pet device manager 126 can track and change those boredom levels over time based on the sensor data.

The palatability level may be a score generated by the pet device manager 126 to indicate how much a cat likes a particular food. The palatability level may base that score on how quickly the cat engages with the food, the duration of the consumption of the food, the actions prior to receiving the food, such as pacing the feeder or yowling, etc. The palatability level can indicate to a user how well the particular cat likes the particular food. This can assist both in user decisions of food over time as the pet device manager 126 can compare data about a particular cat to similar cats from the plurality of cats and identify specific foods that have a high palatability level for cats with similar characteristics. Additionally, in some implementations, this palatability level could be used for real-time testing and feedback with various pet food manufacturers. Pet food with high palatability level scores based on the real-time engagement of the pets with the specific foods can provide insights to the manufacturer and users over which types of foods different pets like and/or how long they engage with those foods (e.g., the boredom level).

The desirability level may be a score generated by the pet device manager 126 to indicate how much a pet desires a particular food. The desirability level can be based on the engagement of the pet with the food over time and determining the various characteristics that indicate that the pet does and/or does not desire the specific food as described above. The desirability level can change over time based on sensor data captured and analyzed by the pet device manager 126. At 1920, the pet device manager 126 can cause the feeder to change a composition of the food in the feeder based on a change in one or more of the boredom level, the palatability level, and/or the desirability level.

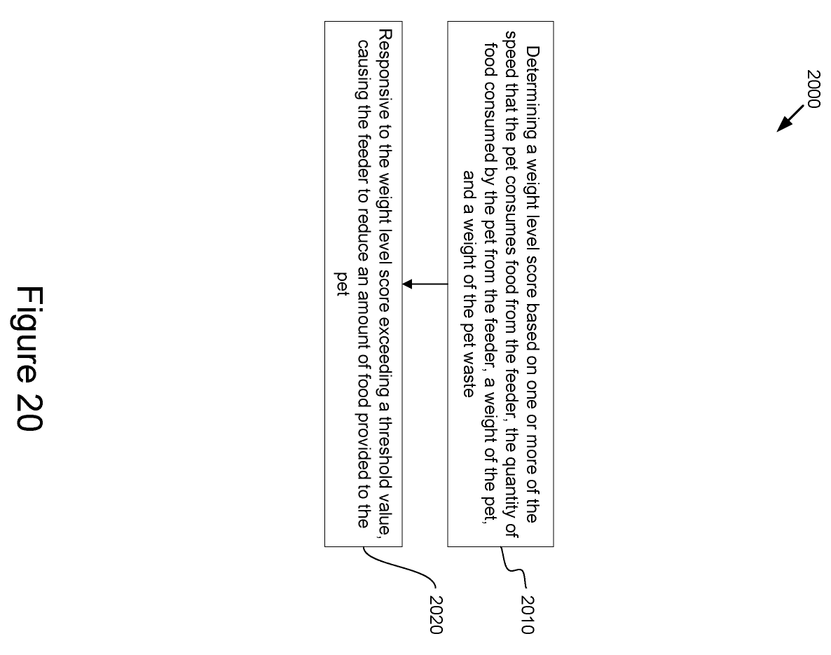

FIG. 20 is a flowchart of an example method 2000 of determining a weight level score and adjusting one or more settings of a connected pet device based on the weight level. At 2010, the pet device manager 126 can determine a weight level score based on one or more of the speed at which the pet consumes food from the feeder, the quantity of food consumed by the pet from the feeder, a weight of the pet, and a weight of the pet waste as described elsewhere herein. The weight level score may be a score indicating whether a pet is at an expected weight based on the characteristics of that pet, or if the pet is above or below the expected weight. The pet device manager 126 can generate the weight level score by comparing the pet to other pets with similar characteristics and expected weights. Once an expected weight is determined for the pets with similar characteristics, then the pet device manager 126 can assign scores based on the comparison of each pet's weight to the expected weight. At 2020, the pet device manager 126 can cause the feeder to reduce the amount of food provided to the pet based on the weight level score indicating that the pet is above the expected level, etc. In other examples, the pet device manager 126 could increase the amount of food if below a level, change a feeding duration or quantity to address a weight level change, or change a subscription to a different food to address a weight level issue.

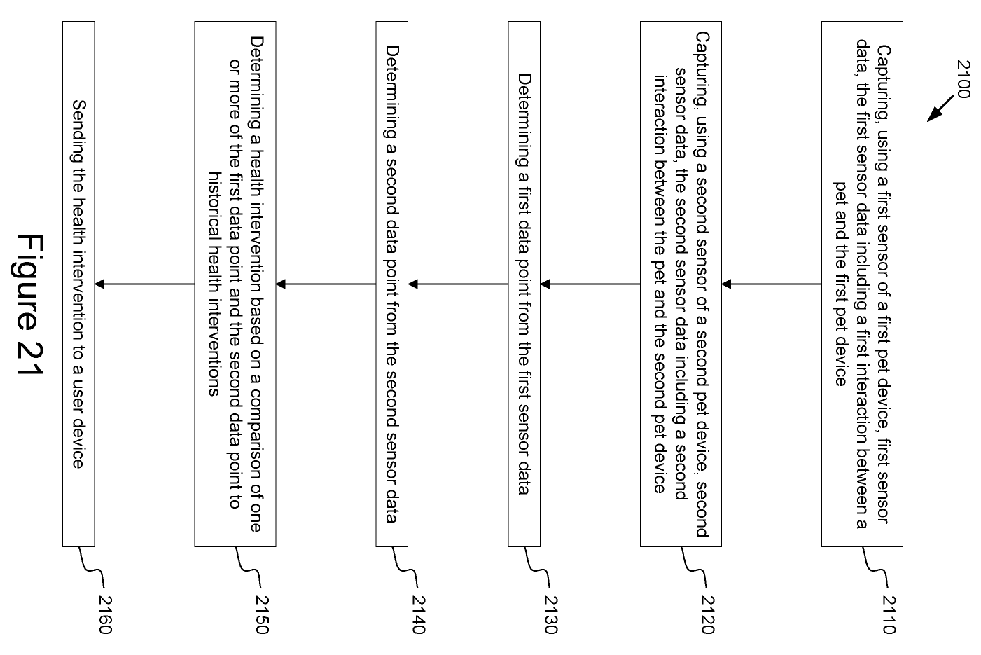

FIG. 21 is a flowchart of an example method 2100 of health intervention based on captured sensor data from a connected pet device. At 2110, the pet device manager 126 can cause a first sensor of a first pet device to capture first sensor data, the first sensor data including a first interaction between a pet and the first pet device as described elsewhere herein. At 2120, the pet device manager 126 can cause a second sensor of a second pet device to capture second sensor data, the second sensor data including a second interaction between the pet and the second pet device as described elsewhere herein. At 2130, the pet device manager 126 can determine a first data point from the first sensor data as described elsewhere herein. At 2140, the pet device manager 126 can determine a second data point from the second sensor data as described elsewhere herein. At 2150, the pet device manager 126 can determine a health intervention based on a comparison of one or more of the first data point and the second data point to historical health interventions as described elsewhere herein. At 2160, the pet device manager 126 can send the health intervention to a user device.

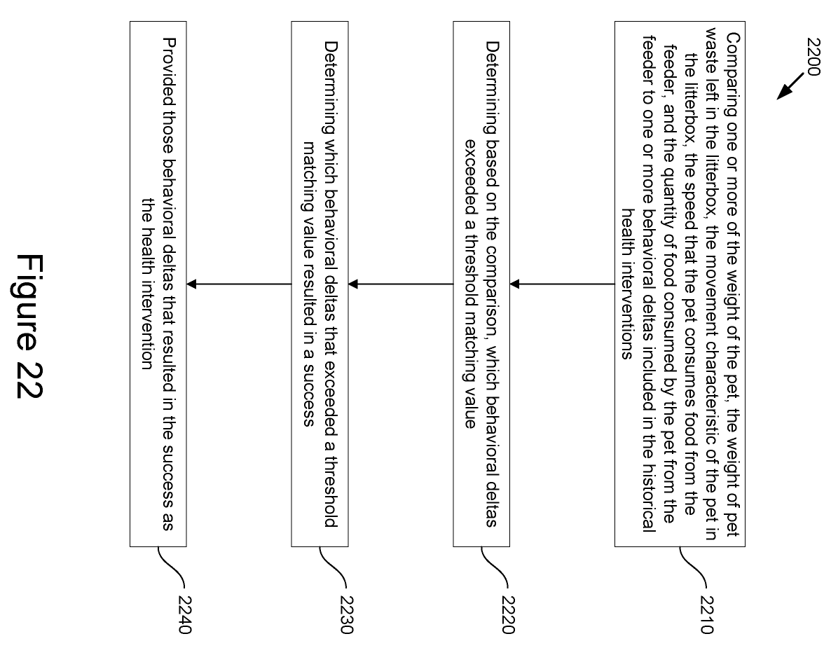

FIG. 22 is a flowchart of an example method 2200 of determining one or more behavioral deltas of previous success for a health intervention based on captured sensor data from a connected pet device. At 2210, the pet device manager 126 can compare one or more of the weight of the pet, the weight of pet waste left in the litterbox, the movement characteristic of the pet in the litterbox, the speed that the pet consumes food from the feeder, and the quantity of food consumed by the pet from the feeder to one or more behavioral deltas included in the historical health interventions. These behavioral deltas may be correlations or other similarities found in the aggregated pet data of other pets that is captured over time. Additionally, the behavioral deltas may identify trends or recommended next steps based on actions taken by pets in the aggregated pet data. At 2220, the pet device manager 126 can determine, based on the comparison, which behavioral deltas exceeded a threshold matching value. The pet device manager 126 can view various different behavioral deltas and organize them/score them as needed to determine which actions/behavioral deltas may be relevant based on the current sensor data of the current pet. At 2230, the pet device manager 126 can determine which behavioral deltas that exceeded a threshold matching value resulted in a success. The success may be identified as an intervention that achieved a positive result. For example, the current sensor data may appear to indicate that the cat is urinating more frequently than normal. The behavioral deltas may identify other similar cats with similar urination frequencies and the next actions taken for those cats. Based on which actions appeared to reduce the urination frequency, those actions would potentially indicate a success and at 2240, the pet device manager 126 could provide those behavioral deltas that resulted in the success as the health intervention as described elsewhere herein.

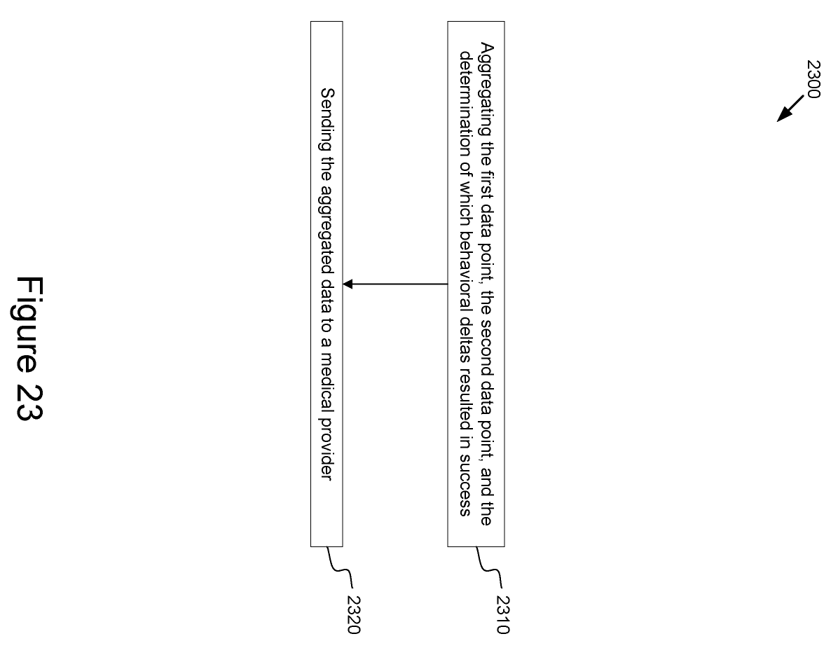

FIG. 23 is a flowchart of an example method 2300 of aggregating captured data from a connected pet device. At 2310, the pet device manager 126 can aggregate the first data point, the second data point, and the determination of which behavioral deltas resulted in success. For example, referencing the above example of frequent urination, the pet device manager 126 can provide the historical data of the cat, the increased frequency of urination, and the actions taken that reduced that frequency, such as prescribing a medication for a UTI or a bladder stone procedure and at 2320, the pet device manager 126 can send the aggregated data to a medical provider, such as the veterinarian for the pet. In some implementations, the veterinarian may be a trusted third party that the pet device manager 126 has been authorized to share information with and the veterinarian can access all of the historical data of the pet captured from the sensor data and use that information to assist in diagnosing issues with the pet.

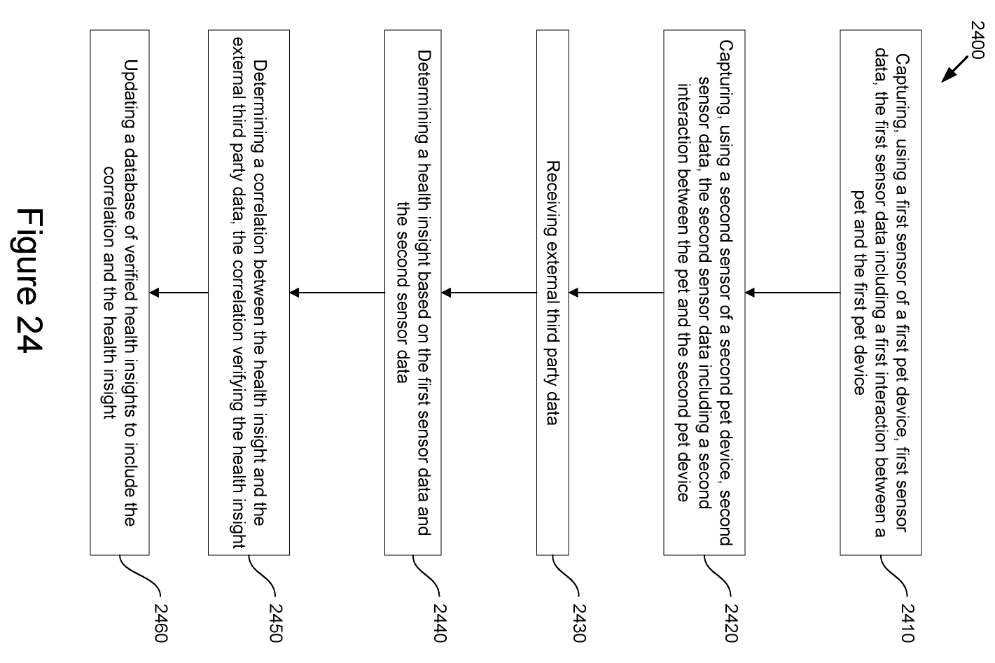

FIG. 24 is a flowchart of an example method 2400 of determining health insights and correlating data that verifies the determined health insights. At 2410, the pet device manager 126 can cause a first sensor of a first pet device to capture first sensor data, the first sensor data including a first interaction between a pet and the first pet device as described elsewhere herein. At 2420, the pet device manager 126 can cause a second sensor of a second pet device to capture second sensor data, the second sensor data including a second interaction between the pet and the second pet device as described elsewhere herein. At 2430, the pet device manager 126 can receive external third-party data. This third-party data may be journal or social media entries related to the pet, calendar information associated with the pet (such as vet appointments, pill reminders, food subscriptions, medical recommendations, indications from the user of a change in the pet’s behavior, search history associated with the pet, etc.

At 2440, the pet device manager 126 can determine a health insight based on the first sensor data and the second sensor data as described elsewhere herein. This health insight may be an inference by the pet device manager 126 that something may be wrong. In some implementations, the health insight may be based on a comparison to the aggregated pet data for similar pets with similar interactions. At 2450, the pet device manager 126 may determine a correlation between the health insight and the external third-party data, the correlation verifying the health insight. For example, the health insight may be an inference that the pet is unwell/sick and the third-party data correlates this inference by indicating that the user scheduled a visit to the veterinarian to address the unwell behaviors that the user independently observed. In another example, the health insight may be a determination that the pet has exceeded a threshold weight value and the correlating data that verifies that may be a user switching a subscription to a diet food or a veterinarian note indicating that feeding should be reduced to lower the pet’s weight, etc. These third-party data sets that correlate to inferred health insight and provide verification help to build a model of predictive data that can be relied upon as more than mere inferences by the pet device manager 126. At 2460, the pet device manager 126 can update a database of verified health insights to include the correlation and the health insight. These verified health insights can be given more weight for future determinations, predictions, and/or inferences and over time as additional actions are verified from external sources, the pet device manager 126 will be able to provide more tailored and relevant inferences based on captured sensor data.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

To ease description, some elements of the system 100 and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise, as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission, or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, including, but not limited to, any type of disk, including floppy disks, optical disks, CD-ROMs, and magnetic disks, read-only memories (ROMs), random access memories (RAMs), EPROMs, EEPROMs, magnetic or optical cards, flash memories, including USB keys with non-volatile memory, or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes, but is not limited to, firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer-readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi^{TM})transceivers, Ethernet adapters, and modems are just a few examples of network adapters. The private and public networks may have any number of configurations and/or topologies. Data may be transmitted between these devices via the networks using a variety of different communication protocols, including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP), and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. As will be understood by those familiar with the art, the specification may be embodied in other specific forms without departing from the spirit or essential characteristics thereof. Likewise, the particular naming and division of the modules, routines, features, attributes, methodologies, and other aspects are not mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
receiving, by one or more processors, sensor data captured from a sensor of a primary pet device, the sensor data including an interaction between a pet and the primary pet device;
determining, by the one or more processors, a profile of the pet using the sensor data; and
updating the profile of the pet to include the sensor data captured from the primary pet device.

2. The computer-implemented method of claim 1, wherein the pet is a feline, the primary pet device is a litterbox, and wherein the interaction between the pet and the primary pet device is the feline using the litterbox.

3. The computer-implemented method of claim 2, wherein the sensor of the primary pet device is one or more weight sensors and the sensor data includes weight data borne by each sensor of the one or more sensors captured when the feline is using the litterbox, the method further comprising:
determining, by the one or more processors, a current weight of the feline based on the weight data; and
determining, by the one or more processors, a waste weight of any feline waste left in the litterbox after the feline uses the litterbox based on the weight data; and
determining, by the one or more processors, a behavior of the feline as it performs one or more actions of entering the litterbox, exiting the litterbox, and maneuvering around the litterbox based on the weight data.

4. The computer-implemented method of claim 3, wherein updating the profile of the pet to include the sensor data captured from the primary pet device including updating the profile of the pet to include the current weight of the feline and the waste weight of any feline waste left in the litterbox.

5. The computer-implemented method of claim 4, further comprising:
determining, by the one or more processors, a health change in the feline by comparing one or more of the current weight of the feline to historical weight data of the feline, the waste weight produced by the feline to historical waste weight data, and the behaviors exhibited by the feline compared to historical behavior exhibited by the feline;
determining, by the one or more processors, a health action based on the health change; and
sending the health action to a user device.

6. The computer-implemented method of claim 1, wherein determining the profile of the pet using the sensor data further comprises:
determining, by the one or more processors, one or more behavioral characteristics of the pet from the sensor data;
comparing, by the one or more processors, the one or more behavioral characteristics to historical behavioral characteristics associated with the pet;
determining, by the one or more processors, that the one or more behavioral characteristics match within a threshold accuracy to the historical behavioral characteristics of the pet; and
associating, by the one or more processors, the one or more behavioral characteristics of the pet from the sensor data with the historical behavioral characteristics of the pet.

7. The computer-implemented method of claim 1, wherein the sensor data is first sensor data, the pet is a first pet, the interaction is a first interaction, and the profile is a first profile, the method further comprising:
receiving, by the one or more processors, second sensor data from the sensor of the primary pet device, the second sensor data including a second interaction between a second pet and the primary pet device;
determining, by the one or more processors, a second profile of the second pet using the second sensor data; and
updating, by the one or more processors, the second profile of the second pet to include the second sensor data captured from the primary pet device.

8. The computer-implemented method of claim 7, wherein determining the first profile of the first pet using the first sensor data and determining the second profile of the second pet using the second sensor data further comprises:
determining, by the one or more processors, that the first sensor data includes first pet information that is associated with one or more historical first pet characteristics;
determining, by the one or more processors, that the first sensor data is from the first pet based on the determination that the first sensor data includes first pet information that is associated with the one or more historical first pet characteristics;
determining, by the one or more processors, the first profile of the first pet based on the determination that the first sensor data is from the first pet;
determining, by the one or more processors, that the second sensor data includes second pet information that is associated with one or more historical second pet characteristics;
determining, by the one or more processors, that the second sensor data is from the second pet based on the determination that the second sensor data includes second pet information that is associated with the one or more historical second pet characteristics; and
determining, by the one or more processors, the second profile of the second pet based on the determination that the second sensor data is from the second pet;

9. The computer-implemented method of claim 8, wherein the one or more historical first pet characteristics and the one or more historical second pet characteristics include pet weight characteristics, movement characteristics within the primary pet device, pet waste characteristics, and timing characteristics.

10. A pet identification system comprising:
a sensor of a pet device, the sensor being configured to capture sensor data of an interaction between a pet and the pet device; and
a pet management application configured to receive the sensor data of the interaction between the pet and the pet device, determine a profile of the pet using the sensor data, and update the profile of the pet to include the sensor data captured from the pet device.

11. The pet identification system of claim 10, wherein the pet is a feline, the pet device is a litterbox, and wherein the interaction between the pet and the pet device is the feline using the litterbox.

12. The pet identification system of claim 11, wherein the sensor of the pet device is one or more weight sensors and the sensor data includes weight data borne by each sensor of the one or more sensors captured when the feline is using the litterbox, and wherein the pet management application is further configured to:
determine a current weight of the feline based on the weight data;
determine a waste weight of any feline waste left in the litterbox after the feline uses the litterbox based on the weight data; and
determine a behavior of the feline as it performs one or more actions of entering the litterbox, exiting the litterbox, and maneuvering around the litterbox based on the weight data.

13. The pet identification system of claim 12, wherein updating the profile of the pet to include the sensor data captured from the pet device including updating the profile of the pet to include the current weight of the feline and the waste weight of any feline waste left in the litterbox.

14. The pet identification system of claim 13, wherein the pet management application is further configured to:
determine a health change in the feline by comparing one or more of the current weight of the feline to historical weight data of the feline, the waste weight produced by the feline to historical waste weight data, and the behaviors exhibited by the feline compared to historical behavior exhibited by the feline;
determine a health action based on the health change; and
send the health action to a user device.

15. The pet identification system of claim 10, wherein the pet management application being configured to determine the profile of the pet using the sensor data is further configured to:
determine one or more behavioral characteristics of the pet from the sensor data;
compare the one or more behavioral characteristics to historical behavioral characteristics associated with the pet;
determine that the one or more behavioral characteristics match within a threshold accuracy to the historical behavioral characteristics of the pet; and
associate the one or more behavioral characteristics of the pet from the sensor data with the historical behavioral characteristics of the pet.

16. The pet identification system of claim 10, wherein the sensor data is first sensor data, the pet is a first pet, the interaction is a first interaction, and the profile is a first profile, the wherein the sensor of the pet device is further configured to capture second sensor data of an second interaction between a second pet and the pet device; and wherein the pet management application is further configured to receive the second sensor data of the second interaction between the second pet and the pet device, determine a second profile of the second pet using the second sensor data, and update the second profile of the second pet to include the second sensor data captured from the pet device.

17. The pet identification system of claim 16, wherein the when the pet management application determines the first profile of the first pet using the first sensor data and determines the second profile of the second pet using the second sensor data, the pet management application is further configured to:
determine that the first sensor data includes first pet information that is associated with one or more historical first pet characteristics;
determine that the first sensor data is from the first pet based on the determination that the first sensor data includes first pet information that is associated with the one or more historical first pet characteristics;
determine the first profile of the first pet based on the determination that the first sensor data is from the first pet;
determine that the second sensor data includes second pet information that is associated with one or more historical second pet characteristics;
determine that the second sensor data is from the second pet based on the determination that the second sensor data includes second pet information that is associated with the one or more historical second pet characteristics; and
determine the second profile of the second pet based on the determination that the second sensor data is from the second pet;

18. The pet identification system of claim 17, wherein the one or more historical first pet characteristics and the one or more historical second pet characteristics include pet weight characteristics, movement characteristics within the pet device, pet waste characteristics, and timing characteristics.

19. A method of multi-pet identification comprising:
detecting, using one or more sensors of a pet device, an interaction between a feline from a plurality of felines and the pet device, the interaction including a waste action by the feline in a litter area of the pet device;
capturing, using the one or more sensors of the pet device, sensor data in response to the interaction being detected, the sensor data including the waste action by the feline in the litter area of the pet device and a behavior action by the feline in the litter area of the pet device;
comparing, using one or more processors, the sensor data including the waste action and the behavior action by the feline in the litter area of the pet device to one or more of historical waste action data and historical behavior action data that includes waste actions from multiple different felines of a plurality of felines and historical behavior action data that includes behavior actions from the multiple different felines of the plurality of felines;
determining, using the one or more processors, a match that exceeds a threshold accuracy between one or more characteristics of the sensor data and one or more characteristics of the one or more of the historical waste action data and the historical behavior action data that is associated with a matched feline of the plurality of felines;
identifying the matched feline of the plurality of felines as the feline in the interaction with the pet device based on the determined match exceeding the threshold accuracy; and
updating a profile of the matched feline to include at least a portion of the sensor data.

20. The method of claim 19, wherein the one or more characteristics of the sensor data include one or more of a weight of the feline, an activity level of the feline, a visit duration of the feline, a waste weight of the feline, and a time characteristic of the feline.
